(19) United States
(12) Patent Application Publication
(10) Pub. No.: US 2002/0062314 A1
(43) Pub. Date: May 23, 2002

(54) Apparatus and method for material management

(75) Inventors: Akiko Hisasue, Tokyo (JP); Junji Tateishi, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Chiyoda-ku (JP)

(21) Appl. No.: 09/883,256

(22) Filed: Jun. 19, 2001

(30) Foreign Application Priority Data
Nov. 20, 2000 (JP) 2000-352929

(51) Int. Cl. G06F 7/00

(52) U.S. Cl. 707/10

(57) ABSTRACT

Provided are a material management apparatus and a material management method which are capable of efficiently managing an adequate amount of stock and order of materials used in a semiconductor manufacturing line. Specifically, an operation part (11) receives data (D3) from a data processing part (10), and receives data (D6) from an operation part (12). The data (D3) is data containing information of a material ID and information of the number of wafers to be processed in a first unit period of time. The data (D6) is data of an endurance limit number of material which is found by the operation part (12). The operation part (11) performs an operation of dividing the number of wafers to be processed by the endurance limit number, to find the number of material needed in processing all the wafers to be processed in the first unit period of time (i.e., an estimated number in use), and then outputs the result as data (D7). The data (D7) is inputted to an order management part (4).

### BACKGROUND OF THE INVENTION

1. Field of the Invention

The present invention relates to a material management apparatus and a material management method which manage the stock and order of materials used in semiconductor manufacturing lines.

2. Description of the Background Art

A variety of materials such as chemicals and apparatus parts are used in a semiconductor manufacturing line. In order to ensure a smooth flow of materials in the semiconductor manufacturing line, it is important to efficiently manage an adequate quantity of stock and order of these materials.

In the stock and order management of materials in the semiconductor manufacturing line, there are the following problems.

Firstly, the purpose of management is dependent on the material, and it is therefore difficult to uniformly manage a variety of materials. Specifically, in the case of managing materials having a quality assurance period (e.g., most chemicals), it is necessary to manage their expiration date of use. On the other hand, since most apparatus parts have no quality assurance period, it is unnecessary to manage their expiration date of use. In contrast, apparatus parts (especially small parts) are usually not determined so as to be stored at a specific place. Therefore, such apparatus parts require management for specifying their respective storage places. On the other hand, most chemicals are determined so as to be stored at a specific place. Therefore, such chemicals require no management for specifying their respective storage places.

Secondly, it is difficult to order an adequate quantity or number of material at the appropriate time. In a semiconductor manufacturing line, the kind of product is changed on demand, and the kind of material used therefor is also changed accordingly. It is therefore difficult to know the necessary quantity or number of materials that should be kept in stock. In many cases, this becomes excess order with fear of stockout, and material that has passed the expiration date of use is required to be discarded, thus causing much waste cost (i.e., the cost irrelevant to the manufacture).

### SUMMARY OF THE INVENTION

According to a first aspect of the invention, a material management apparatus comprises: an estimated number in use calculating part to calculate, based on data of an operating manufacturing line, an estimated number in use of material including apparatus parts in a unit period of time; a stock management part to manage stock of the material on data; and an order management part to output data on an ordering number of the material based on data of the estimated number in use from the estimated number in use calculating part and data of a current stock number of the material from the stock management part.

According to a second aspect of the invention, the material management apparatus of the first aspect is characterized in that the estimated number in use calculating part has: a first operation part to calculate an endurance limit of the material based on data of the number of wafers processed in a unit period of time and data of the number of the material used in the unit period of time; and a second operation part to calculate the estimated number in use based on data of the number of wafers to be processed and data of the endurance limit from the first operation part.

According to a third aspect of the invention, the material management apparatus of the first aspect further comprises a storage part to store data of plural predetermined items about the material, wherein the stock management part performs stock management of the material by referring to the data stored in the storage part, and the order management part performs order management of the material by referring to the data stored in the storage part.

According to a fourth aspect of the invention, the material management apparatus of the first aspect further comprises a storage part to store data of plural predetermined items about the material, wherein the material includes chemicals; that the storage part further stores masters having plural management items including items needed in managing the apparatus parts and items needed in managing the chemicals; and that the stock management part manages, per the material as a management object, by selecting a specific item from the plural management items.

According to a fifth aspect of the invention, the material management apparatus of the third aspect is characterized in that the plural predetermined items include an item about storage place of the material.

According to a sixth aspect of the invention, the material management apparatus of the third aspect is characterized in that the plural predetermined items include an item about expiration date of use of the material.

According to a seventh aspect of the invention, the material management apparatus of the third aspect is characterized in that the plural predetermined items include an item about expiration date of use of the material currently used within a processing apparatus.

According to an eighth aspect of the invention, the material management apparatus of the third aspect is characterized in that the plural predetermined items include an item indicating whether the material is currently a management object or not.

According to a ninth aspect of the invention, the material management apparatus of the eighth aspect further comprises a display part to separately display, on different screens, a stock management data of the material that is currently a management object and a stock management data of the material that is currently not a management object.

According to a tenth aspect of the invention, the material management apparatus of the third aspect is characterized in that the plural predetermined items include an item indicating whether or not the material is a material usable by repetitive reproduction.

According to an eleventh aspect, the material management apparatus of the eighth aspect further comprises a display part to separately display, on different screens, an order data of the material to be purchased and an order data of the material to be reproduced.

According to a twelfth aspect of the invention, the material management apparatus of the first aspect is characterized in that the order management part outputs data of the ordering number of the material based on data of the estimated number in use, data of the current stock number, and an upper limit value of an ordering number that is defined by a predetermined expression.

According to a thirteenth aspect of the invention, the material management apparatus of the twelfth aspect is characterized in that the upper limit value of the ordering number is defined by the predetermined expression using a delivery time of the material as a parameter.

According to a fourteenth aspect of the invention, the material management apparatus of the twelfth aspect is characterized in that when the material is a material having a quality assurance period, the upper limit value of the ordering number is defined by the predetermined expression using, as a parameter, a delivery time and the quality assurance period of the material.

According to a fifteenth aspect of the invention, the material management apparatus of the first aspect is characterized in that the order management part determines an order time of the material based on a predetermined expression using, as a parameter, an actual number used of the material in a unit period of time, a delivery time of the material, and the current stock number of the material.

According to a sixteenth aspect of the invention, the material management apparatus of the first aspect is characterized in that the order management part outputs data of an ordering number of the material by converting the unit of the material adopted within the material management apparatus, into the unit of the material adopted by a manufacturer to which the material is ordered.

According to a seventeenth a aspect, a material management method comprises the steps of: (a) calculating an estimated number in use of material including apparatus parts in a unit period of time, based on data of an operating manufacturing line; (b) finding a current stock number of the material; and (c) determining an ordering number of the material based on data of the estimated number in use and data of the current stock number.

According to an eighteenth aspect, the material management method of the seventeenth aspect is characterized in that the step (a) has the steps of: (a-1) calculating an endurance limit of the material based on data of the number of wafers processed in a unit period of time and data of the number of the material used in the unit period of time; and (a-2) calculating the estimated number in use, based on data of a number of wafers to be processed and data of the endurance limit.

The first aspect can realize efficient management in appropriate amount of stock and order not only with respect to chemicals but also apparatus parts.

With the second aspect, the accurate estimated number in use of material can be obtained by utilizing data about the number of wafers processed in the past unit period of time and data about the number of material used in that unit period of time.

With the third aspect, linkage between the stock management of material conducted in the stock management part and the order management of material conducted in the order management part (i.e., an increase in the efficiency of management) is facilitated by storing, in the storage part, data of predetermined items needed in the stock management and order management of the material.

With the fourth aspect, only the necessary items can be managed exhaustively according to the purpose of managing the material that is a management object.

With the fifth aspect, management of storage place can be performed with respect to material of which storage place needs to be specified.

With the sixth aspect, material having a quality assurance period can be subjected to management of its expiration date of use.

With the seventh aspect, material that is currently used within a specific apparatus and has a quality assurance period can be subjected to management of its expiration date of use.

With the eighth aspect, in the event that material will not be used in the future because an apparatus requiring the use of the material is discarded, or the relevant development or experience is terminated, thereafter, any order or stockpiling of the material can be stopped by referring to a management data, thus avoiding an increase in waste (unnecessary) stock.

With the ninth aspect, the operator can avoid complications of retrieving a management data about material that is not currently a management object, from the vast amounts of management data.

With the tenth aspect, when the material as a management object is a material that is usable repetitively by reproduction process, it is able to perform an appropriate order by using the necessary parameters depending on the purpose (i.e., purchase or reproduction).

With the eleventh aspect, data for purchase order and data for reproduction order are separated and displayed on different screens, in order to avoid that a purchase order is mistaken for a reproduction order.

With the twelfth aspect, excess order of material is avoidable by setting the upper limit value of the ordering number of the material.

With the thirteenth aspect, the upper limit value of the ordering number of material can be set appropriately according to the length of delivery time of the material.

With the fourteenth aspect, the upper limit value of the ordering number of material can be set appropriately according to the length of delivery time and the length of quality assurance period of the material.

With the fifteenth aspect, it is avoidable that if the order of material is too early, the period of time from stockpiling of the material to its expiration date of use becomes short, and that if the order of material is too late, the material is not yet stockpiled when necessary.

With the sixteenth aspect, the order of material is managed in the unit that is unified within the material management apparatus, whereas its ordering is executable in the unit adopted by a manufacturer receiving the order.

The seventeenth aspect can realize efficient management in appropriate amount of stock and order not only with respect to chemicals but also apparatus parts.

With the eighteenth aspect, the accurate estimated number in use of material can be obtained by utilizing data about the number of wafers processed in the past unit period of time and data about the number of material used in that unit period of time.

It is an object of the present invention to overcome the foregoing problems by providing a material management apparatus and a material management method which are capable of efficiently managing the adequate amount of stock and order of materials used in a semiconductor manufacturing line.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram schematically illustrating the overall constitution of a material management apparatus according to a previous technique of the present invention;

FIG. 2 is a block diagram schematically illustrating the overall constitution of a material management apparatus according to the invention;

FIG. 3 is a block diagram specifically illustrating the constitution of an estimated number in use calculating part according to a first preferred embodiment of the invention;

FIG. 4 is a flowchart showing the operations of the estimated number in use calculating part in the first preferred embodiment;

FIG. 5 is a diagram illustrating the contents stored in a storage part according to a second preferred embodiment of the invention;

FIG. 6 is a diagram illustrating a specific example of a material master;

FIG. 7 is a diagram illustrating a specific example of an apparatus master;

FIG. 8 is a diagram illustrating a specific example of a unit master;

FIG. 9 is a diagram illustrating a specific example of an operator master;

FIG. 10 is a diagram illustrating a specific example of a storage place master;

FIG. 11 is a diagram illustrating a specific example of a reason for replacement master;

FIG. 12 is a diagram illustrating a specific example of a purchase order destination master;

FIG. 13 is a diagram illustrating a specific example of a reproduction order destination master;

FIG. 14 is a diagram illustrating a specific example of a quality assurance period master;

FIG. 15 is a block diagram illustrating the constitution of a material management apparatus according to the second preferred embodiment;

FIG. 16 is a flowchart showing the operations of managing storage places of materials in the material management apparatus of the second preferred embodiment;

FIG. 17 is a diagram illustrating a specific example of data about storage places of materials;

FIG. 18 is a diagram illustrating a specific example of a management list of storage places of materials;

FIG. 19 is a block diagram illustrating the constitution of a material management apparatus according to a third preferred embodiment of the invention;

FIG. 20 is a flowchart showing the operations of managing the expiration date of use of materials in the material management apparatus of the third preferred embodiment;

FIG. 21 is a diagram illustrating a specific example of data about the expiration date of use of materials;

FIGS. 22A and 22B are diagrams illustrating a specific example of a management list of the expiration date of use of materials;

FIG. 23 is a block diagram illustrating the constitution of a material management apparatus according to a fourth preferred embodiment of the invention;

FIG. 24 is a flowchart showing the operations of managing the expiration date of use of materials in the material management apparatus of the fourth preferred embodiment;

FIG. 25 is a diagram illustrating a specific example of data about the expiration date of use of materials;

FIG. 26 is a diagram illustrating a specific example of a management list of the expiration date of use of materials;

FIG. 27 is a block diagram illustrating the constitution of a material management apparatus according to a fifth preferred embodiment of the invention;

FIG. 28 is a flowchart showing the operations of managing materials in the material management apparatus of the fifth preferred embodiment;

FIG. 29 is a block diagram illustrating, the constitution of a material management apparatus according to a sixth preferred embodiment of the invention;

FIG. 30 is a flowchart showing the operations of managing purchase order or reproduction order of materials in the material management apparatus of the sixth preferred embodiment;

FIG. 31 is a block diagram illustrating the constitution of a material management apparatus according to a seventh preferred embodiment of the invention;

FIG. 32 is a diagram illustrating a specific example of a material master in the seventh preferred embodiment;

FIG. 33 is a flowchart showing the operations of managing the number of purchase order of materials in the material management apparatus of the seventh preferred embodiment;

FIG. 34 is a block diagram illustrating the constitution of a material management apparatus according to an eighth preferred embodiment of the invention;

FIG. 35 is a flowchart showing the operations of managing the purchase order time of materials in the material management apparatus of the eighth preferred embodiment;

FIG. 36 is a block diagram illustrating the constitution of a material management apparatus according to a ninth preferred embodiment of the invention;

FIG. 37 is a diagram illustrating a specific example of a material master in the ninth preferred embodiment;

FIG. 38 is a flowchart showing the operations of managing the unit conversion of materials in the material management apparatus of the ninth preferred embodiment; and

FIG. 39 is a block diagram illustrating other constitution of the material management apparatus in the ninth preferred embodiment.

### DESCRIPTION OF THE PREFERRED EMBODIMENTS

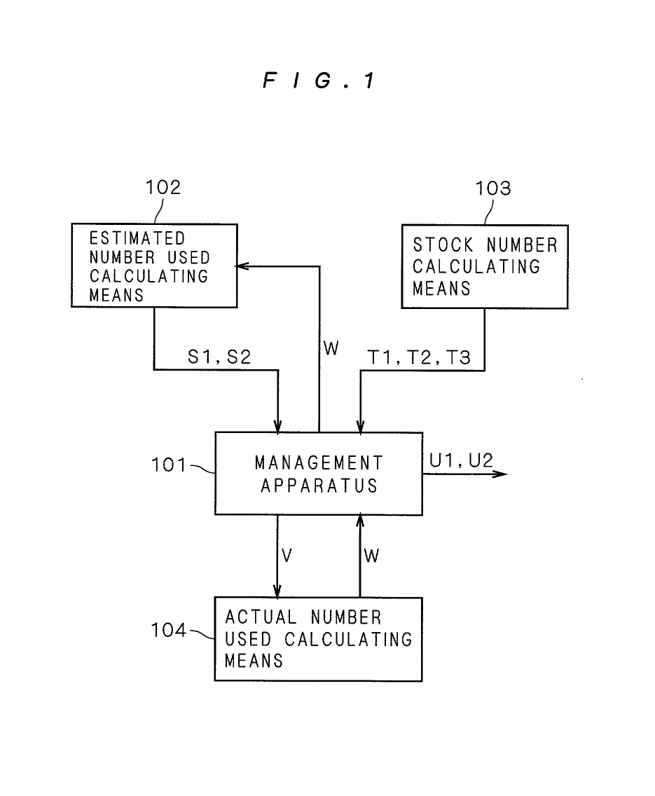

As a previous technique of the present invention, description will proceed to a material management apparatus disclosed in Japanese patent application (Japanese Patent Application Laid-Open No. 2000-147165) filed by the present inventors. FIG. 1 is a block diagram schematically illustrating the overall constitution of this material management apparatus. This apparatus makes chemicals having a quality assurance period an object of management. An estimated number in use calculating means 102 calculates an estimated number in use of a material which is to be used in a first unit period of time (e.g., one month), and then outputs the obtained number as data S1. A stock number calculating means 103 calculates the stock number of the material and then outputs the obtained number as data T1. The data T1 contains information related to the expiration date of use of the material. A management apparatus 101 receives the data S1 from the estimated number in use calculating means 102 and the data T1 from the stock number calculating means 103. Then, the management apparatus 101 compares the estimated number in use of the material in the first unit period of time, with the stock number of the material of which expiration date of use does not fall within that unit period of time, thereby outputting data U1 about the ordering number of the material.

After the first unit period of time, the management apparatus 101 receives, from the stock number calculating means 103, data T2 about the number of the material actually used in the first unit period of time, and then calculates the number of wafers actually processed in a semiconductor manufacturing line in the first unit of period, and then outputs such information as data V. An actual number used calculating means 104 receives the data V from the management apparatus 101, and calculates the number used of the material per wafer (an actual number used), and then outputs the result as data W.

The estimated number in use calculating means 102 receives, via the management apparatus 101, the data W from the actual number used calculating means 104. Based on the actual number used in the first unit period of time and the number of wafers to be processed in the following second unit period of time, the estimated number in use calculating means 102 calculates an estimated number in use in the second unit period of time and outputs the result as data S2. The management apparatus 101 receives the data S2 from the estimated number in use calculating means 102, and data T3 from the stock number calculating means 103. The data T3 is data about the stock number of the material. Like the data T1, the data T3 also contains information about the expiration date of use of the material. Based on the data S2 and data T3, the management apparatus 101 calculates the ordering number of the material in the second unit period of time and then outputs the result as data U2.

Thus, the material management apparatus as described has such a function of counting the consumption of the material in the past unit period of time and calculating the actual number used of the material per wafer, to perform a feedforward to the next estimation. This enables to obtain an accurate estimation depending on the kind and number of the material.

The present invention is an improvement over the foregoing material management apparatus and realizes a stock management suitable not only for chemicals but also materials such as apparatus parts having an endurance limit number (i.e., consumable parts). In the present specification, the term “material” means apparatus parts of semiconductor manufacturing apparatuses used in semiconductor manufacturing lines, and materials such as chemicals used for processing wafers in the semiconductor manufacturing apparatuses in the semiconductor manufacturing lines.

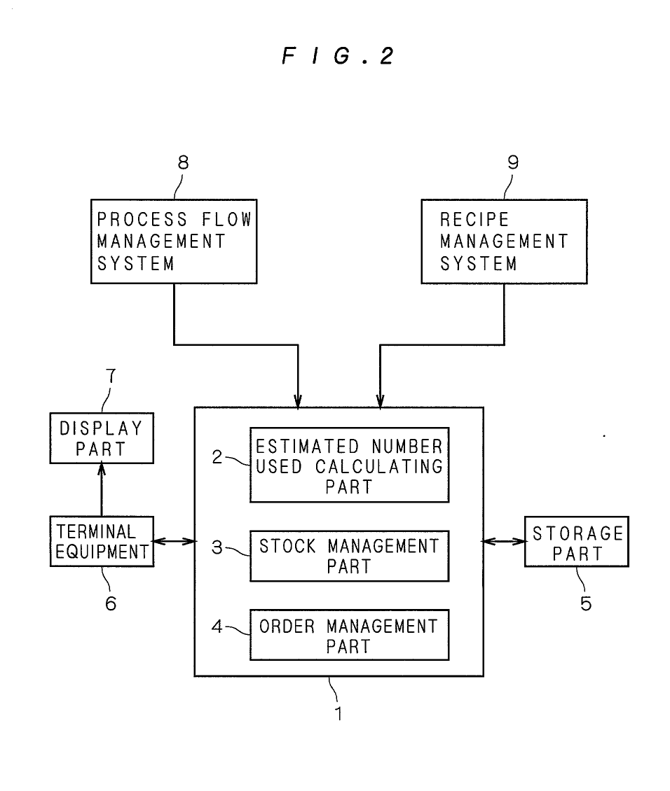

FIG. 2 is a block diagram schematically illustrating the overall constitution of a material management apparatus according to the present invention. This material management apparatus comprises a data processing apparatus 1 having an estimated number in use calculating part 2, stock management part 3 and order management part 4; a terminal equipment 6 and storage part 5 which are connected to the data processing apparatus 1; and a display part 7 connected to the terminal equipment 6. The followings are specific preferred embodiments of the material management apparatus according to the invention.

First Preferred Embodiment

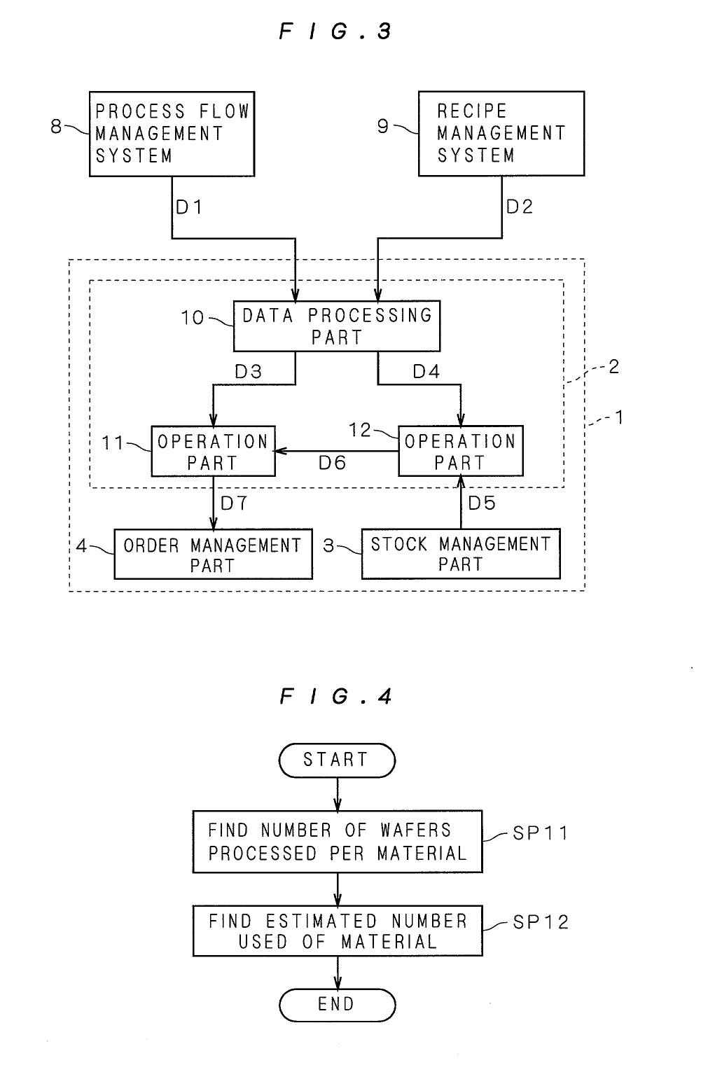

FIG. 3 is a block diagram specifically illustrating the constitution of an estimated number in use calculating means 2 according to a first preferred embodiment of the invention. The estimated number in use calculating means 2 comprises a data processing part 10; an operation part 12 connected to the output of the data processing part 10; and an operation part 11 connected to the respective outputs of the data processing part 10 and the operation part 12. The data processing part 10 is also connected to a process flow management system 8 and recipe management system 9. which are disposed outside of the system. The process flow management system 8 is a system to manage the flow of a lot manufacturing process in a semiconductor manufacturing line. The recipe management system 9 is a system to manage the contents of a recipe (specification) that describes the contents of processing in each manufacturing process. The operation part 11 is connected to an order management part 4, and the operation part 12 is connected to a stock management part 3.

FIG. 4 is a flowchart showing the operations of the estimated number in use calculating part 2 in the first preferred embodiment. The operations of the material management apparatus of the first preferred embodiment will be described in the case, for example, that a management object is a consumable part. Referring to FIG. 4, the estimated number in use calculating part 2 firstly finds the number of wafers processed per material (step SP11). Specifically, referring to FIG. 3, the data processing part 10 firstly receives data D1 from the process flow management system 8 and data D2 from the recipe management system 9. The data D1 is data containing information about the number of wafers to be processed in a first unit period of time, e.g., one month, (an estimated number processed), and information about the number of wafers processed in a second unit period of time in the past, e.g., the last one month (an actual number used). The data D2 is data containing the name of the material being the management object (a material ID) and information about the kind of a recipe and its contents. Based on the kind of the recipe that is a common item, the data processing part 10 collects the information about the material and the number of wafers which are given from the process flow management system 8 and the recipe management system 9, respectively.

The operation part 12 receives data D4 from the data processing part 10 and data D5 from the stock management part 3. The data D4 is data containing information about the material ID and information about the actual number used of the wafers. The data D5 is data containing information about the stock number reduced in the second unit period of time, that is, the number of the material used in the second unit period of time (the actual number used). The operation part 12 then performs such an operation that the actual number used of the wafers is divided by the actual number used of the material, thereby to find the average value of the number of the wafers processed per material in the second unit period of time.

Referring to FIG. 4, the estimated number in use calculating part 2 then finds the estimated number in use of the material (step SP12). Specifically, referring to FIG. 3, the operation part 11 receives data D3 from the data processing part 10 and data D6 from the operation part 12. The data D3 is data containing information about the material ID and information about the estimated number processed of the wafers in the first unit period of time. The data D6 is data about the endurance limit number of the material, which has been obtained by the operation part 12. The operation part 11 performs an operation of dividing the estimated number processed of the wafers by the endurance limit number, thereby to find the number of the material necessary for processing all the wafers to be processed in the first unit period of time (i.e., the estimated number in use), and then outputs the results as data D7. The data D7 is inputted to the order management part 4 and used in the order management of the material.

The foregoing description is given of the case that the unit period of time is set to the time unit of one month, however, other time unit such as two weeks or three months may be set as a unit period of time.

Alternatively, based on the last replacement date of a consumable part, the endurance limit number of a material and the number of wafers processed, the next replacement time of the consumable part can be managed in a semiconductor manufacturing line. Thereby, the operator can check a consumable part currently used, or can identify the cause of a trouble of some kind.

Thus, the material management apparatus of the first preferred embodiment can realize an efficient management in appropriate amount of stock and order not only with respect to chemicals but also the consumable parts of apparatuses.

Second Preferred Embodiment

In a second preferred embodiment, description will proceed to a material management apparatus and a material management method by which the stock management part 3 can realize an efficient management of material in an appropriate amount by making chemicals and apparatus parts an object of management.

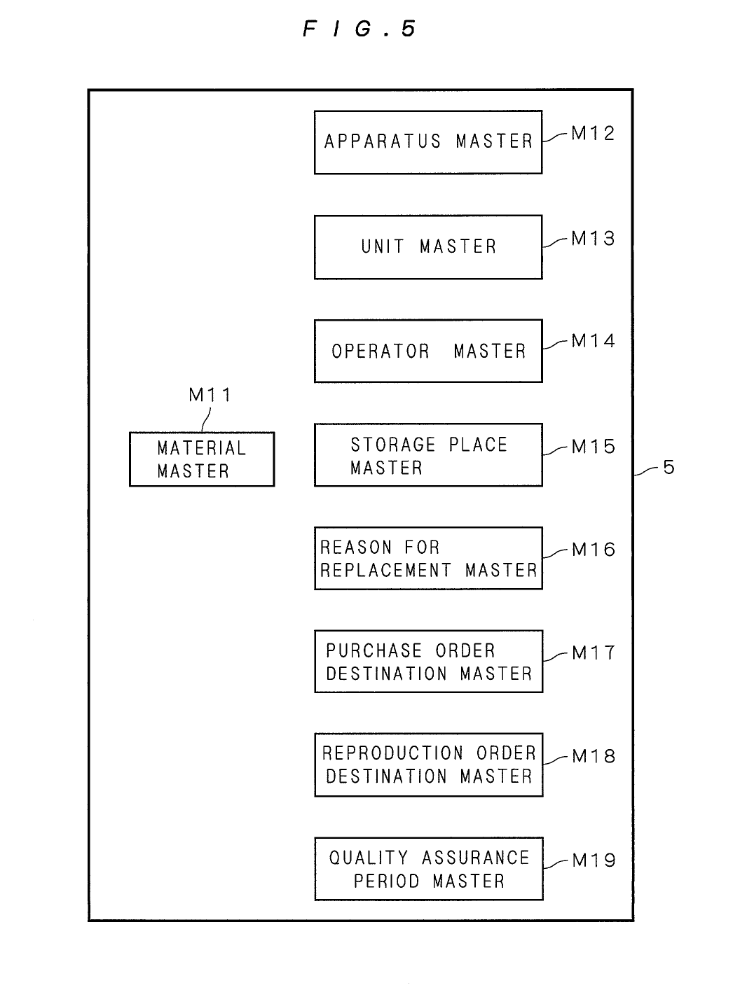

FIG. 5 is a diagram showing the contents of storage of a storage part 5 according to the second preferred embodiment. In the storage part 5, there are stored, as a master data, a variety of information such as a material master M11, apparatus master M12, unit master M13, operator master M14, storage place master M15, reason for replacement master M16, purchase order destination master M17, reproduction order destination master M18, and quality assurance period master M19.

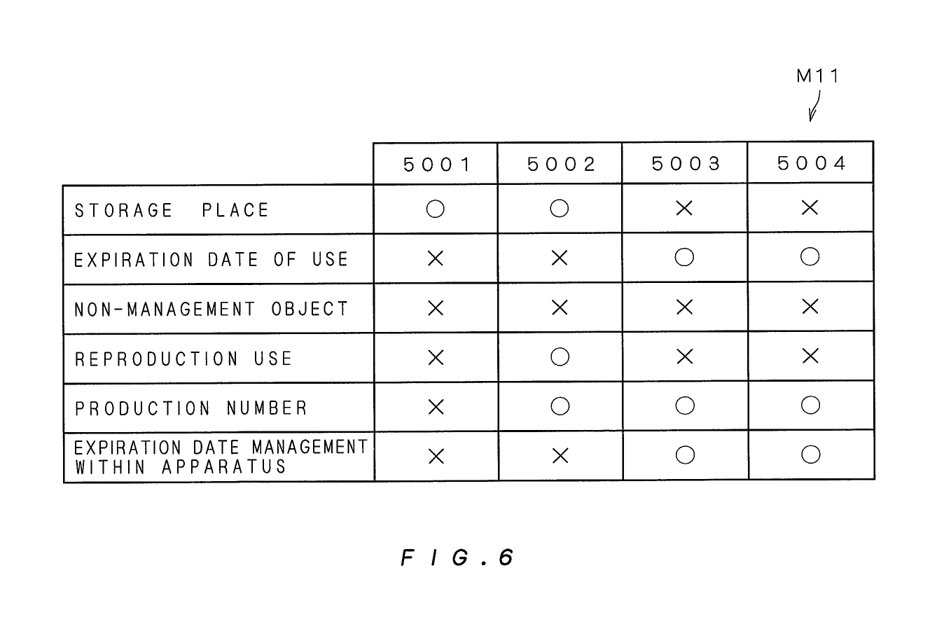

FIG. 6 is a diagram illustrating a specific example of the material master M11. As shown in FIG. 6, the material master M11 is provided with a plurality of management items such as “storage place”, “expiration date of use”, “non-management object”, “reproduction use”, “production number” and “expiration date management within apparatus.” For each material indicted by the material ID, which item should be managed is described by the mark “◯” that means to set the item to ON or the mark “X” that means to set the item to OFF. For instance, in the example shown in FIG. 6, the material ID 5001 is subjected only to management of storage place.

Item “storage place” is adopted as a management item, when the material is an apparatus part, for example. Management of storage place will fully be described later. Item “expiration date of use” is adopted as a management item, when the material is a chemical having a quality assurance period. Management of expiration date of use in storage places will fully be described in a third preferred embodiment.

Item “non-management object” is adopted as a management item, regardless of whether the material is a chemical or apparatus part. Item “non-management object” is usually set to the mark “X”. However, this item is set to the mark “◯” when the material will not be used in the future because the apparatus requiring the use of the material is discarded, or the relevant development or experience is terminated. Management of “non-management object” will fully be described in a fifth preferred embodiment.

Item “reproduction use” is adopted as a management item when the material is a material that is usable by repetitive reproduction (including washing) within a predetermined number of times. Examples of such material are apparatus parts such as expensive quartz tubes. Management of reproduction use will be described in a sixth preferred embodiment. Item “production number” is adopted as a management item, regardless of whether the material is a chemical or apparatus part. If at least either of the items “expiration date of use” and “reproduction use” is set to “◯”, the item “production number” is also set to “◯”.

Item “expiration date management within apparatus” is adopted as a management item, when the expiration date of use of material currently used in an apparatus is managed in such an operation that the material is a material having a quality assurance period and the material is periodically used in the apparatus. Management of the expiration date of use within apparatus will fully be described in a fourth preferred embodiment.

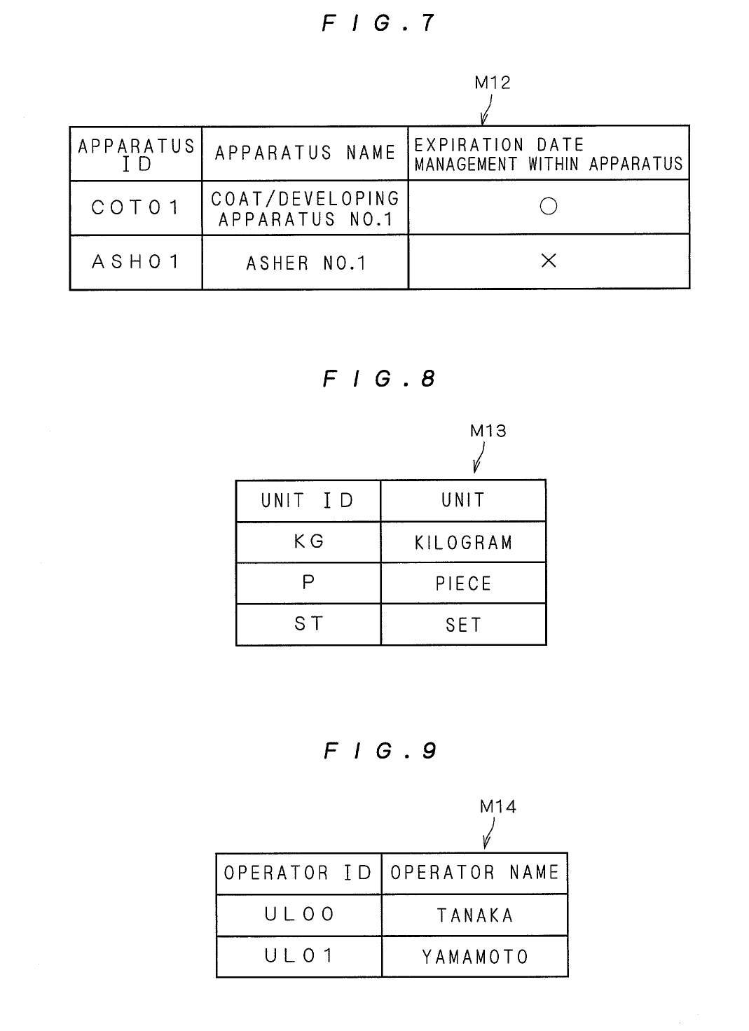

FIG. 7 is a diagram illustrating a specific example of the apparatus master M12. As shown in FIG. 7, the apparatus master M12 is a master data indicating the correspondence among apparatus ID, apparatus name, and whether the apparatus is subjected to expiration date management within apparatus. FIG. 8 is a diagram illustrating a specific example of the unit master M13. As shown in FIG. 8, the unit master M13 is a master data indicating the correspondence between unit ID and unit. FIG. 9 is a diagram illustrating a specific example of the operator master M14. As shown in FIG. 9, the operator master M14 is a master data indicating the correspondence between operator ID and the name of operator.

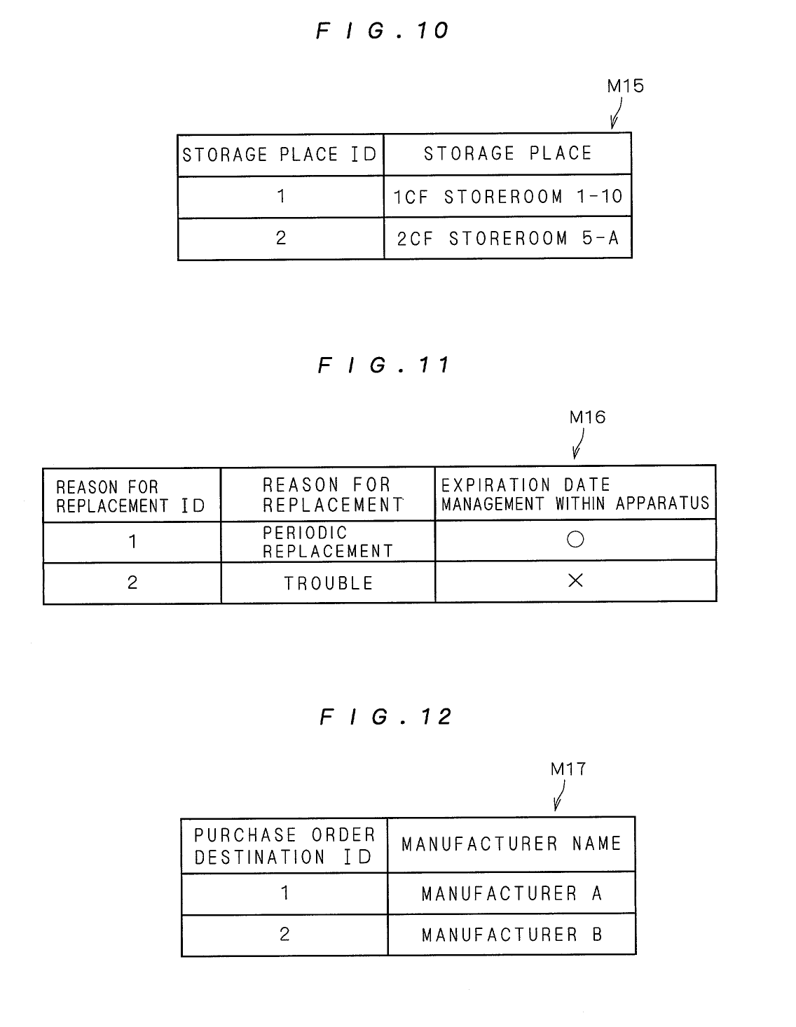

FIG. 10 is a diagram illustrating a specific example of the storage place master M15. As shown in FIG. 10, the storage place master M15 is a master data indicating the correspondence between storage place ID and storage place. FIG. 11 is a diagram illustrating a specific example of the reason for replacement master M16. As shown in FIG. 11, the reason for replacement master M16 is a master data indicating the correspondence among reason for replacement ID, reason for replacement, and whether the apparatus is subjected to expiration date management within apparatus. FIG. 12 is a diagram illustrating a specific example of the purchase order destination master M17. As shown in FIG. 12, the purchase order destination master M17 is a master data indicating the correspondence between purchase order destination ID and the name of a manufacture to which a purchase order of material is performed.

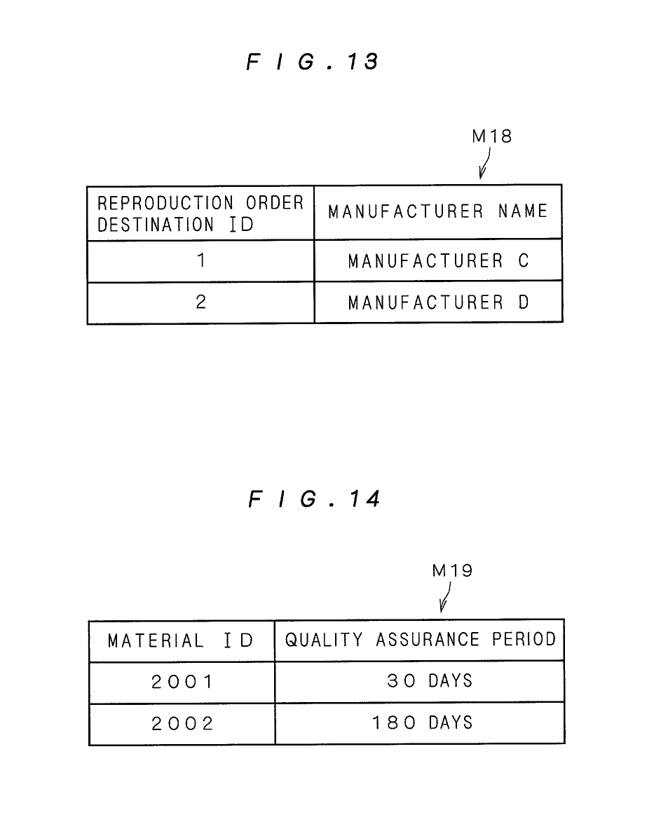

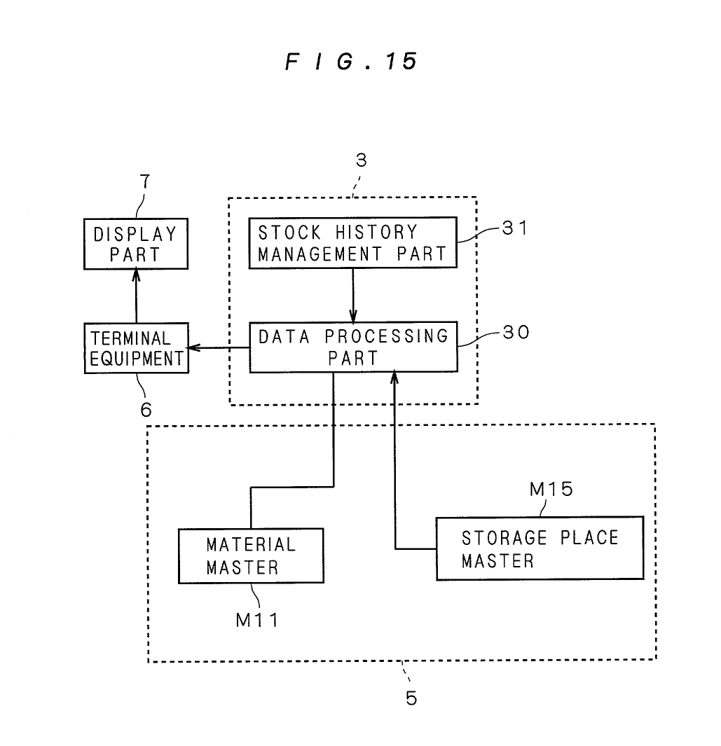

FIG. 13 is a diagram illustrating a specific example of the reproduction order destination master M18. As shown in FIG. 13, the reproduction order destination master M18 is a master data indicating the correspondence between reproduction order destination ID and the name of a manufacturer to which a reproduction order of material (including washing) is performed. FIG. 14 is a diagram illustrating a specific example of the quality assurance period master M19. As shown in FIG. 14, the quality assurance period master M19 is a master data indicating the correspondence between material ID and quality assurance period of material.

Management of storage place of material in a material management apparatus according to the second preferred embodiment will be described hereinafter. FIG. 15 is a block diagram illustrating the constitution of the material management apparatus of the second preferred embodiment. A storage management part 3 has a stock history management part 31 that manages the arrival and delivery of materials, and a data processing part 30 connected to the stock history management part 31 and a terminal equipment 6. A minimum master data needed in managing the storage place of material, that is, only a material master M11 and a storage place master M15, are shown in a storage part 5 in FIG. 15.

FIG. 16 is a flowchart showing the operations of managing the storage place of material in the material management apparatus of the second preferred embodiment. Referring to FIG. 16, the data processing part 30 firstly refers to the contents of the material master M11, and judges the material ID of material, the item “storage place” of which is set to the mark “◯” (step SP21).

The data processing part 30 then extracts a master data needed in managing the storage place of the material, from a plurality of master data stored in the storage part 5 (step SP22). Specifically, referring to FIG. 15, the data processing part 30 extracts, from the material master M11 and storage place master M15, the material name, storage place and storage place ID which correspond to the material ID judged in the step SP21, thereby receiving their respective data. The data processing part 30 then receives data about the current stock number of the material from the stock history management part 31 (step SP23).

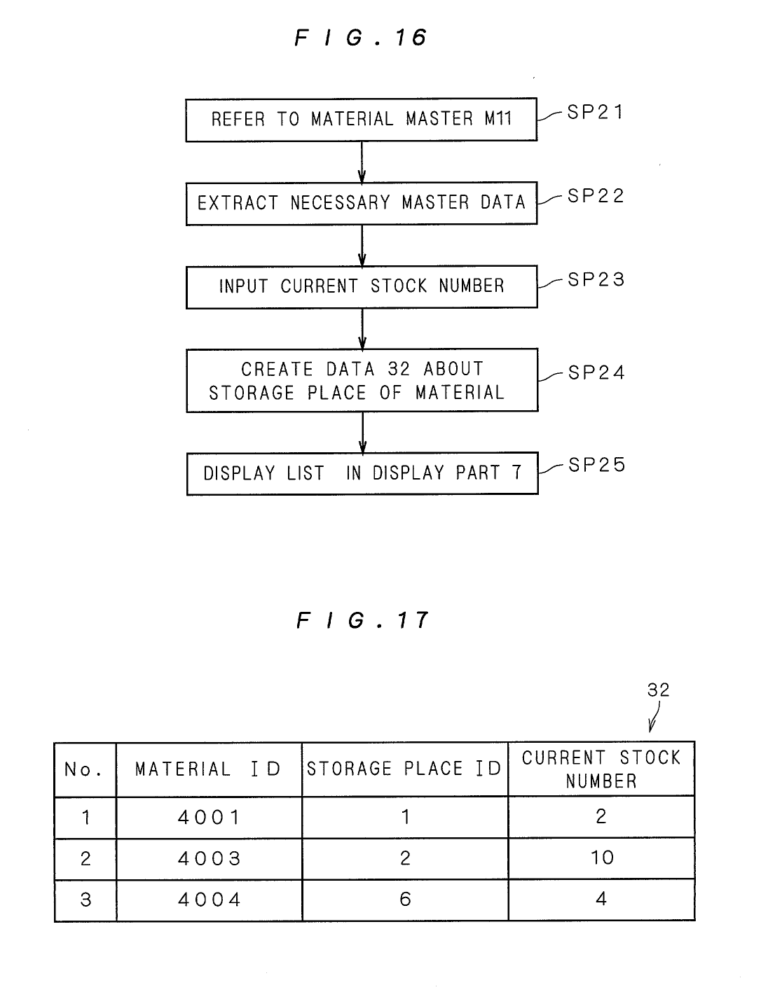

Based on the material master M11, storage place master M15 and the data from the stock history management part 31, the data processing part 30 creates data 32 about the storage place of the material (step SP24). FIG. 17 is a diagram illustrating a specific example of the data 32 about the storage place of materials. In the data 32, the correspondence among material ID, storage place ID and current stock number, is described per material. Information indicated by other master data such as of operators may be arbitrarily combined and described in the data 32. The same is true for other data 34 and 36 to be described later. The data 32 is inputted from the data processing part 30 to the terminal equipment 6.

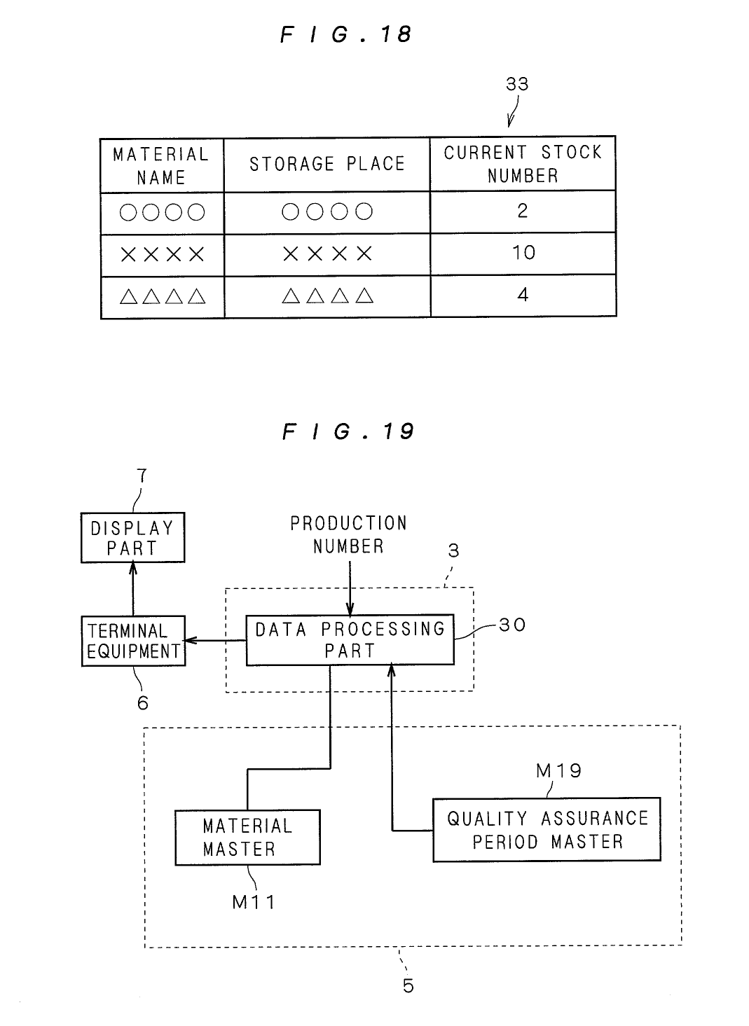

The terminal equipment 6 converts the material ID and storage place ID described in the data 32, into a material name and a storage place, respectively, and creates a management list 33 about the storage places of materials and then displays the management list 33 in the display part 7 (step SP25). FIG. 18 is a diagram illustrating a specific example of the management list 33 about the storage places of materials. In the management list 33, the correspondence among material name, storage place and current stock number is described per material.

Thus, with the material management apparatus of the second preferred embodiment, only the items needed per material can be managed exhaustively by presetting each item of the material master M11 to the mark “◯” or “X”, depending on the purpose of managing the material.

For instance, with respect to an apparatus part requiring management of storage place, the item “storage place” of the material master M11 is set to “◯”. With respect to a chemical requiring no management of storage place, the item “storage place” of the material master M11 is set to “X”. Thereby, management is made only with respect to the material requiring management of storage place.

Third Preferred Embodiment

In a third preferred embodiment, description will proceed to a material management apparatus and a material storage method which are capable of managing the expiration date of use of materials, such as chemicals having a quality assurance period, in a stock management part 3. Management of the expiration date of use of material in the material management apparatus of the third preferred embodiment will be described hereinafter. FIG. 19 is a block diagram illustrating the constitution of this material management apparatus. The stock management part 3 has a data processing part 30 connected to a terminal equipment 6. A minimum master data needed in managing the expiration date of use of material, that is, only a material master M11 and a quality assurance period master M19, are shown in a storage part 5 in FIG. 19.

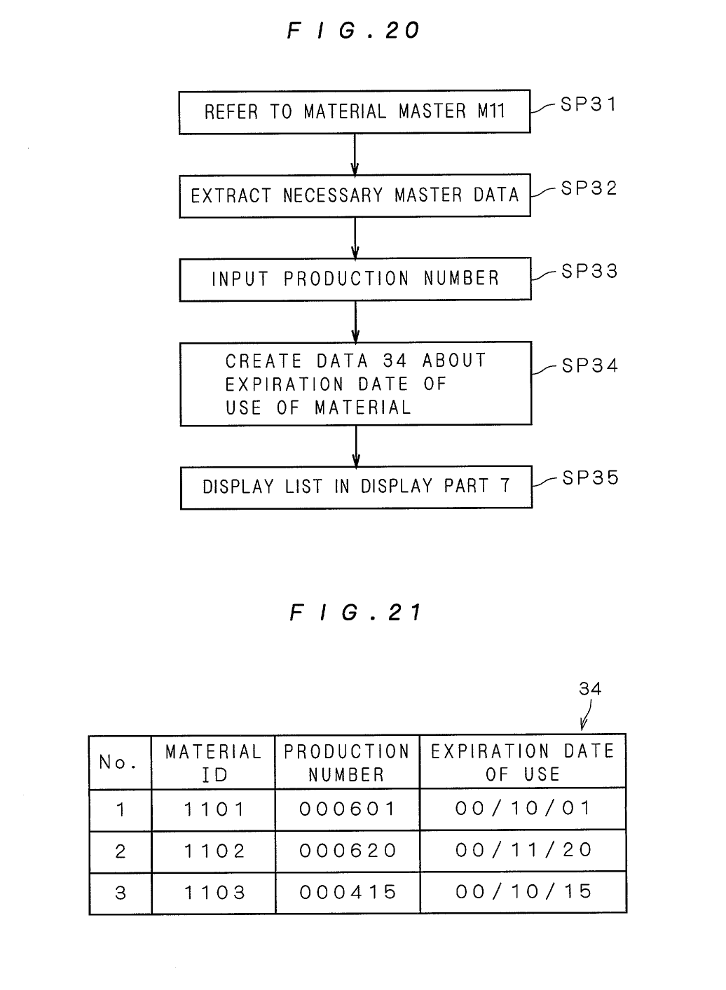

FIG. 20 is a flowchart showing the operations of managing the expiration date of use of material in the material management apparatus of the third preferred embodiment. Referring to FIG. 20, the data processing part 30 firstly refers to the contents of the material master M11, and judges the material ID of material, the item “expiration date of use” of which is set to the mark “◯” (step SP31).

The data processing part 30 then extracts a master data needed in managing the expiration date of use of material, from a plurality of master data stored in the storage part 5 (step SP32). Specifically, referring to FIG. 19, the data processing part 30 extracts, from the material master M11 and quality assurance period master M19, the material name and quality assurance period which correspond to the material ID judged in the step SP31, thereby receiving their respective data. The data processing part 30 then receives the production number of the material that corresponds to the material ID judged in the step S31 (step SP33). The production number of the material is inputted by the operator when the material is stockpiled, and then stored in the material management apparatus so as to correspond to the material ID of the material.

Based on the data from the material master M11 and quality assurance period master M19, and the production number of the material, the data processing part 30 creates data 34 about the expiration date of use of the material (step SP34). FIG. 21 is a diagram illustrating a specific example of the data 34 about the expiration date of use of the material. In the data 34, the correspondence among material ID, production number and expiration date of use of material is described per material. The date 34 is inputted from the data processing part 30 to the terminal equipment 6. The production number of the material contains information about the date of manufacture of the material. The data processing part 30 performs an operation of adding the date of manufacture and the quality assurance period of the material, thereby finding the expiration date of use for each production number of the material. If the production number of material contains no information about the date of manufacture, information about the date of manufacture of the material may be inputted to the date processing part 30, besides the production number of the material.

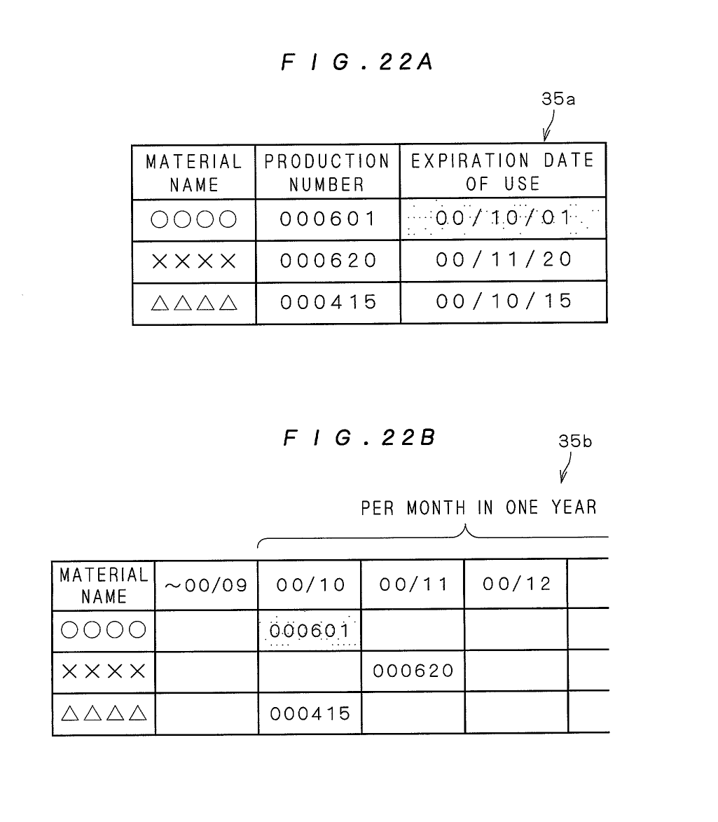

The terminal equipment 6 converts the material ID described in the data 34 into the material name, and creates management lists 35a and 35b about the expiration date of use of the material, and then displays the management lists 35a and 35b in the display part 7 (step SP35). FIGS. 22A and 22B are diagrams illustrating a specific example of the management lists 35a and 35b about the expiration date of use of materials. In the management list 35a, the date (year/month/date) on which the use of material expires is listed so as to correspond to the material name and the production number of the material. In the management list 35b, the production number of material of which expiration date of use falls within that month, is listed so as to correspond to the material name. As shown in FIGS. 22A and 22B, the background of the column of material that has the expiration date of use may be colored for display by using a color different from the color of other column. This makes it easy to recognize quickly the material that has the expiration date of use.

Thus, with the material management apparatus of the third preferred embodiment, only the items needed per material can be managed exhaustively by presetting each item of the material master M11 to the mark “◯” or “X”, depending on the purpose of managing the material.

For instance, with respect to a chemical having a quality assurance period, the item “expiration date of use” of the material master M11 is set to “◯”. With respect to an apparatus part requiring no management of the expiration date of use, the item “expiration date of use” of the material master M11 is set to “X”. Thereby, management is made only for the material requiring management of the expiration date of use.

Fourth Preferred Embodiment

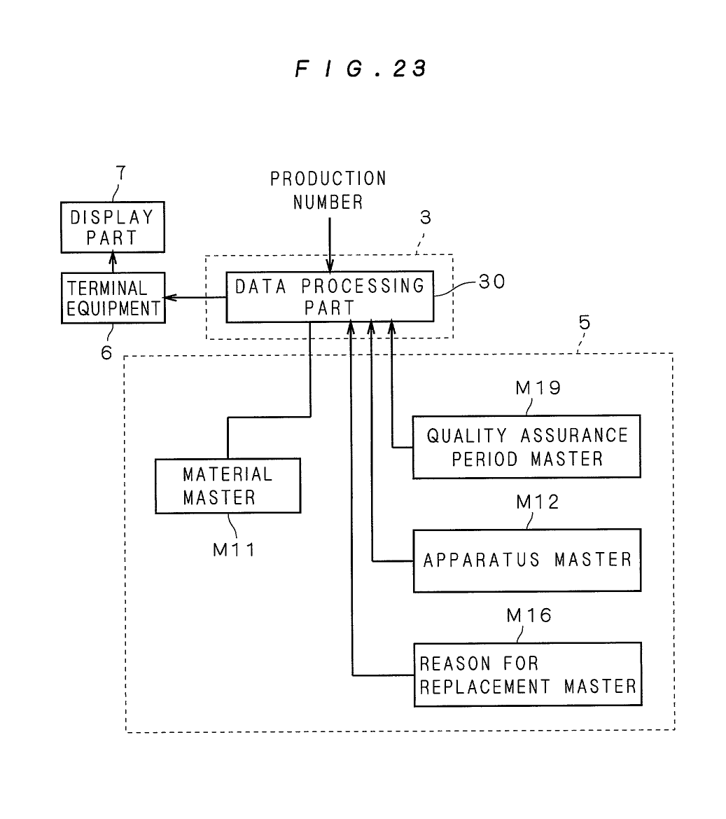

In a fourth preferred embodiment, description will proceed to a material management apparatus and a material management method which are capable of managing the expiration date of use not only with respect to materials stored as stock, but also materials currently used within a processing apparatus. Management of the expiration date of use of material in the material management apparatus of the fourth preferred embodiment will be described hereinafter. FIG. 23 is a block diagram illustrating the constitution of the material management apparatus of the fourth preferred embodiment. A stock management part 3 has a data processing part 30 connected to a terminal equipment 6. A minimum master data needed in managing the expiration date of use of material currently used in an apparatus, that is, only a material master M11, quality assurance period master M19, apparatus master M12 and reason for replacement master M16, are shown in a storage part 5 in FIG. 23.

The stock management part 3 manages the stock history of materials. Specifically, the history of the reason for delivery and the date of delivery is managed per material. Examples of the reason for delivery are “use within apparatus” and “discarding due to trouble” (which correspond to the reasons for replacement ID1 and ID2 of the reason for replacement master M16 as shown in FIG. 11, respectively). In the case of material subjected to expiration date management within apparatus, its production number is also managed.

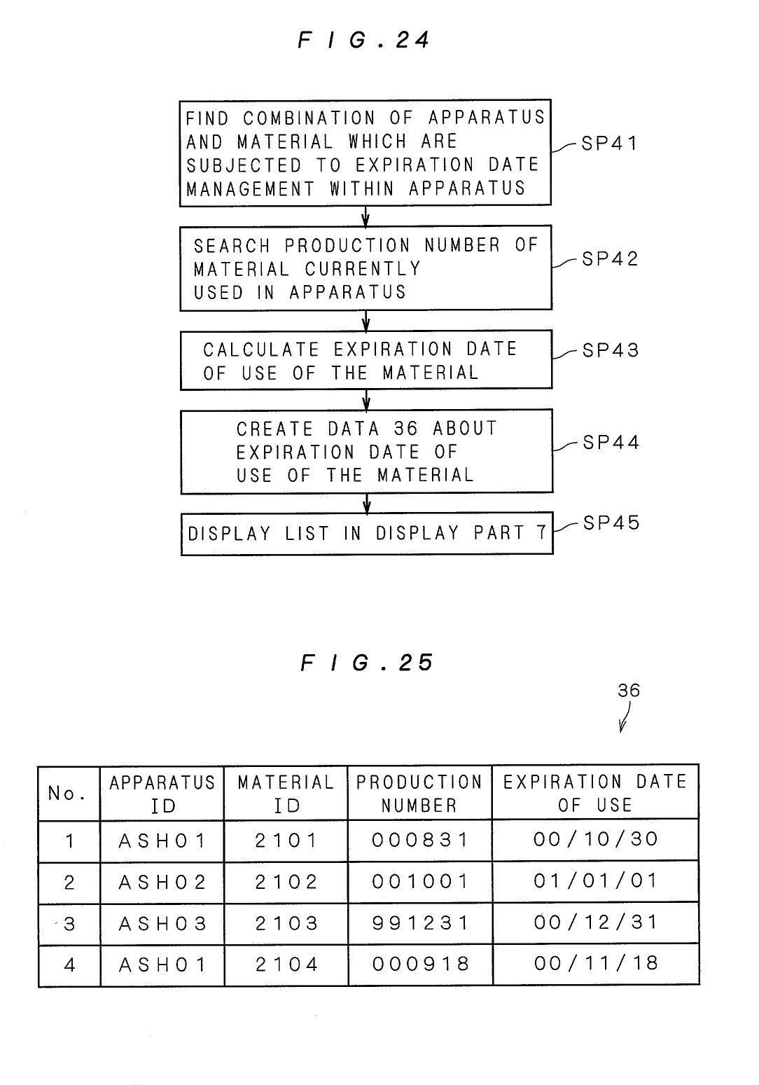

FIG. 24 is a flowchart showing the operations of managing the expiration date of use of materials in the material management apparatus of the fourth preferred embodiment. Referring to FIG. 24, the data processing part 30 firstly refers to each of the contents of the apparatus master M12 and material master M11, and judges the item “expiration date management within apparatus,” thereby finding a combination of an apparatus to be subjected to expiration date management within apparatus and a material to be subjected to expiration date management within apparatus (step SP41).

The data processing part 30 then refers to the stock history of the above material to search the production number of material currently used within apparatus (step SP42). Specifically, the item “expiration date management within apparatus” of each of the apparatus master M12, material master M11 and reason for replacement master M16 is checked to find the stock history of the material subjected to expiration data management within apparatus which is delivered to be used within an apparatus subjected to expiration data management within apparatus. Of the stock history thus obtained, the production number of one which has the latest date of delivery is found as the production number of the material currently used within apparatus.

The data processing part 30 then refers to the quality assurance period master M19 and calculates, based on the production number found in the step SP42, the expiration date of use of the material (step SP43).

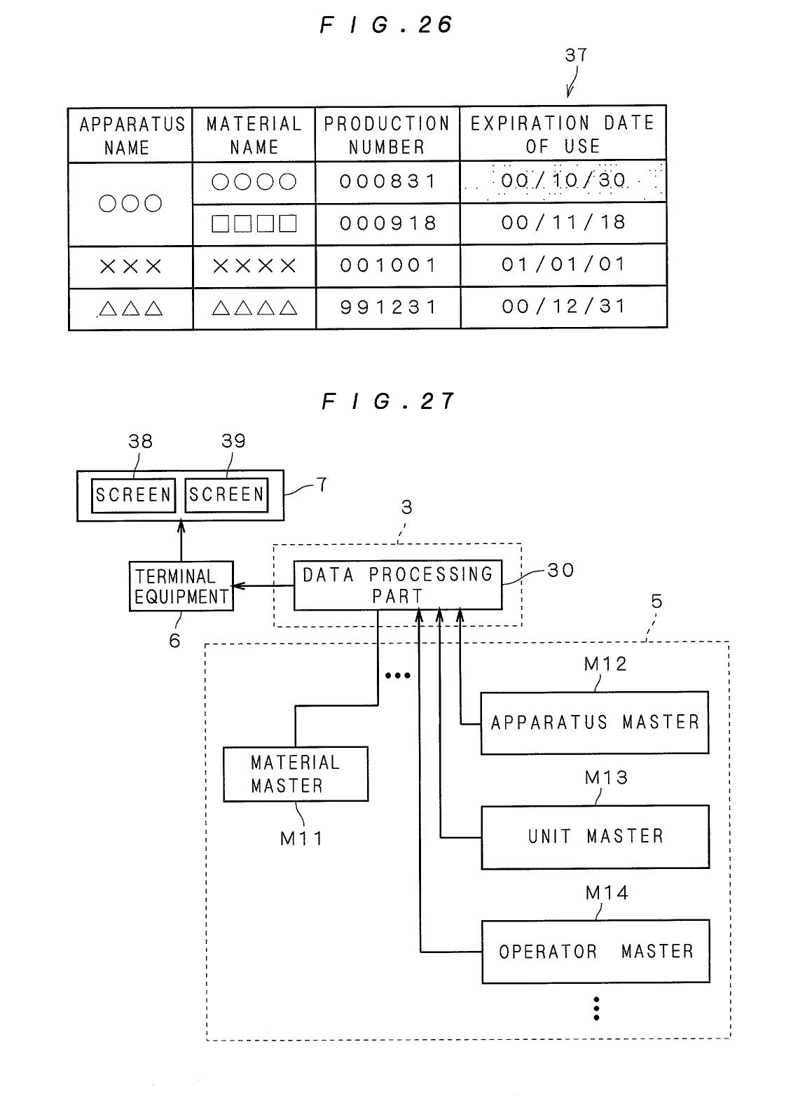

Subsequently, based on the combination of the apparatus and material subjected to expiration date management within apparatus (which is found in the step SP41), on the production number of the material currently used within apparatus (which is obtained in the step SP42), and on the expiration date of use of the material (which is calculated in the step SP43), the data processing part 30 creates data 36 about the expiration date of use of the material (step SP44). FIG. 25 is a diagram illustrating a specific example of the data 36 about the expiration date of use of material. In the data 36, the material ID, the production number and the expiration date of use are described per apparatus ID. The data 36 is inputted from the data processing part 30 to the terminal equipment 6.

The terminal equipment 6 converts the apparatus ID and material ID described in the data 36 into the apparatus name and material name, respectively, and creates a management list 37 about the expiration date of material, and then displays the management list 37 in the display part 7 (step SP45). FIG. 26 is a diagram illustrating a specific example of the management list 37 about the expiration date of use of materials. In the management list 37, the material name, production number and expiration date of use are listed per the name of apparatus in which the material is used. Like the management lists 35a and 35b in FIGS. 22A and 22B, the background of the column of material that has the expiration date of use may be colored for display by using a color different from the color of other column.

Thus, with the material management apparatus of the fourth preferred embodiment, only the items needed per material can be managed exhaustively by presetting each item of the material master M11 to the mark “◯” or “x” depending on the purpose of managing the material.

For instance, with respect to a chemical having a quality assurance period and the material of a consumable apparatus part, the item “expiration date management within apparatus” of the material master M11 is set to “◯”, and each of the item “expiration date management within apparatus” of the apparatus master M12 and the reason for replacement master M16 is set to “◯”. Thereby, management is made only with respect to the material and apparatus which require management of the expiration date of use. This enables to avoid such a disadvantage that when a material is being used within an apparatus, its expiration date of use comes and a manufacturing process is adversely affected.

Fifth Preferred Embodiment

In the foregoing second preferred embodiment, the item “non-management object” is provided to the material master M11 in order to manage whether the material is currently a management object or not. If the material set as non-management object is ordered thereafter, it merely goes to waste. However, it is complicated for the usual operator to retrieve all the data corresponding to materials of many kinds (e.g., several thousands kinds) and check whether the material to be ordered is a non-management object. Accordingly, a fifth preferred embodiment provides a material management apparatus and a material management method which are capable of easily determining whether the material is a non-management object or not.

Management of materials in the material management apparatus of the fifth preferred embodiment will be described hereinafter. FIG. 27 is a block diagram illustrating the constitution of this material management apparatus. A stock management part 3 has a data processing part 30 connected to a terminal equipment 6. A variety of master data as shown in FIG. 5 are stored in a storage part 5 in FIG. 27.

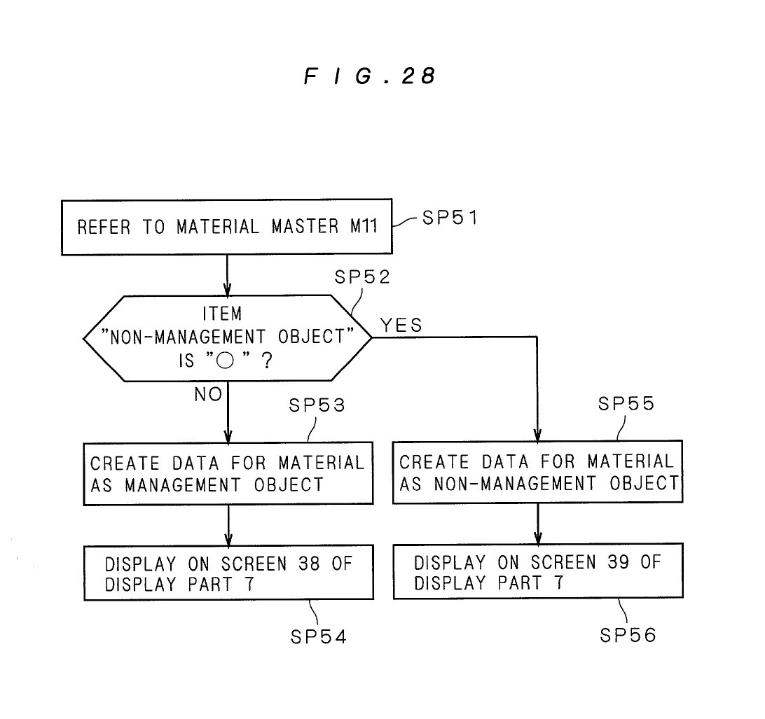

FIG. 28 is a flowchart showing the operation of managing materials in the material management apparatus of the fifth preferred embodiment. Referring to FIG. 28, the data processing part 30 firstly refers to the contents of a material master M11 (step SP51), and then checks whether the item “non-management object” of each material is set to the mark “◯” or not (step SP52).

In creating the data 32, 34 and 36 described in the foregoing second, third and fourth preferred embodiments, the data processing part 30 separates materials based on the results of the step SP52, to create data separately. Specifically, with respect to the material decided as “NO” in the step SP52, data used for material that is a management object is created in step SP53. On the other hand, with respect to the material decided as “YES” in the step SP52, data used for material that is a non-management object is created in step SP55.

The data created in the step SP53 is inputted to the terminal equipment 6, and a management list corresponding to this data is displayed on a screen 38 of a display part 7. The data created in the step SP55 is inputted to the terminal equipment 6, together with an identification code indicating that the material is a non-management object. The management list corresponding to this data is displayed on a screen 39 different from the screen 38, in the display part 7.

In a stockpiling process performed when material is stockpiled, the stockpiling process (by means of access from the screen 39) is inhibited if the material is a non-management object, by referring to the identification code indicating that the material is a non-management object. Further, an ordering process (by means of access from the screen 39) of the material as non-management object is inhibited by inputting the above identification code to the order management part 4.

Thus, with the material management apparatus of the fifth preferred embodiment, a management list about materials currently being management object and a management list about materials currently not being management object, are displayed on the different screens 38 and 39 in the display part 7. Therefore, the operator can easily distinguish whether the material is a management object or not, by referring to the display part 7.

Sixth Preferred Embodiment

In the foregoing second preferred embodiment, the item “reproduction use” is provided to the material master M11. In the case that a reproducible material is purchased or reproduced, because there are different manufactures and unit prices, it is necessary to suitably use two kinds of data, depending on the purpose (i.e., purchase or reproduction). Accordingly, a sixth preferred embodiment provides a material management apparatus and a material management method which are capable of easily distinguishing a purchase order from a reproduction order, and performing its ordering with the necessary data, depending on the purpose.

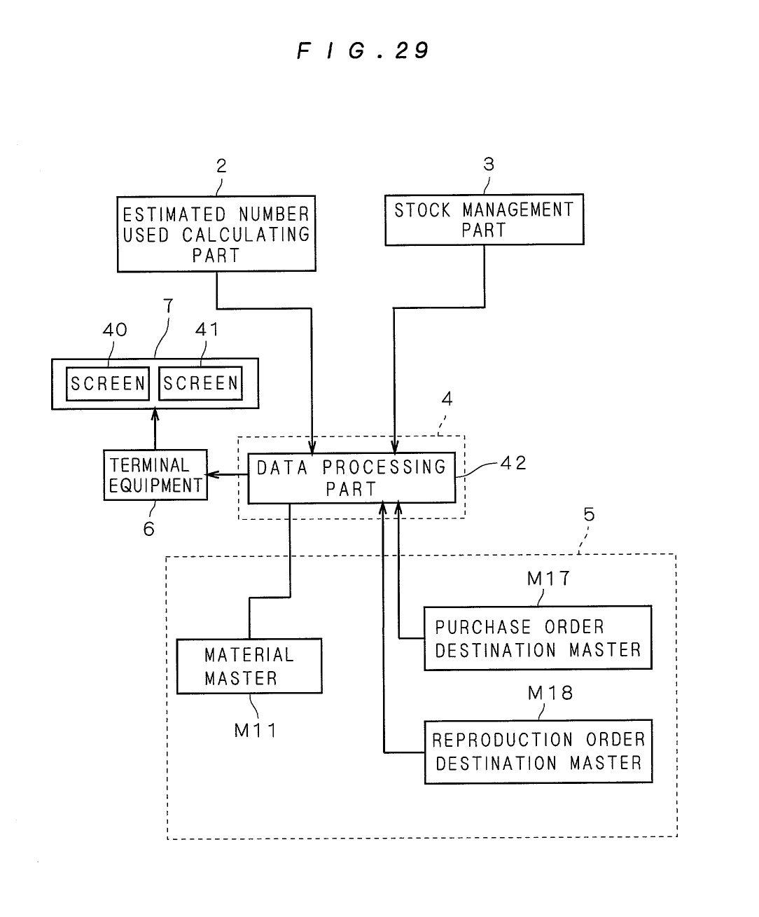

FIG. 29 is a block diagram illustrating the constitution of the material management apparatus of the sixth preferred embodiment. An order management part 4 has a data processing part 42 connected to a terminal equipment 6. A minimum master data needed in managing the purchase order or reproduction order of material, that is, only a material master M11, purchase order destination master M17 and reproduction order destination master M18, are shown in a storage part 5 in FIG. 29.

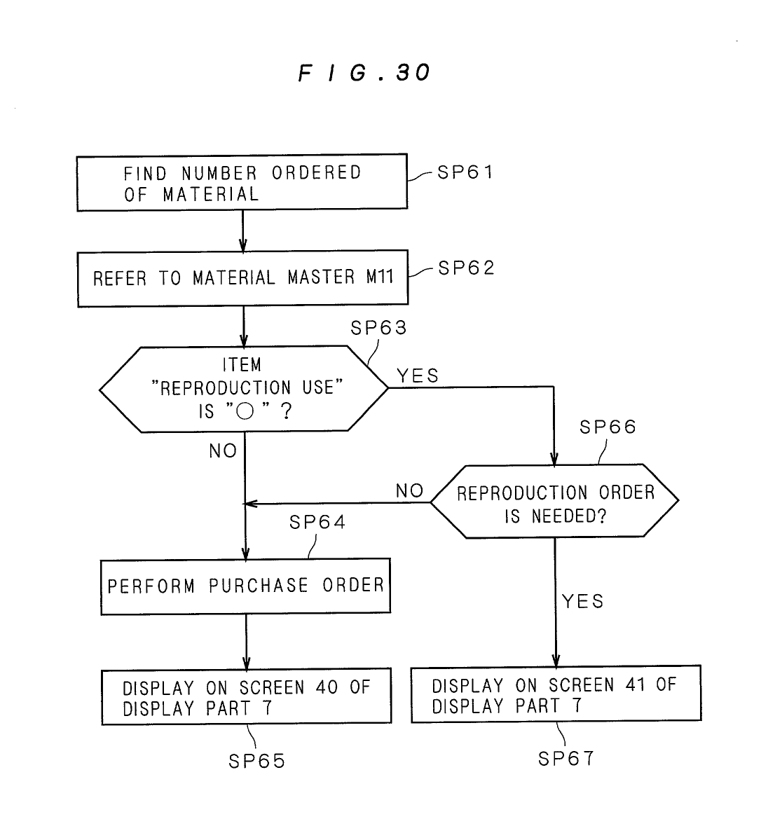

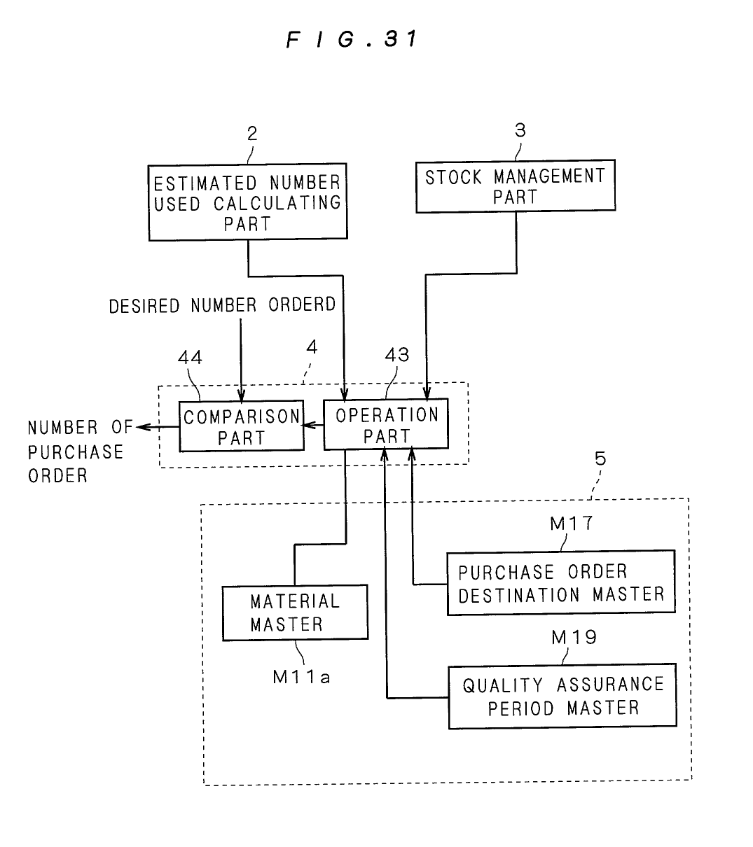

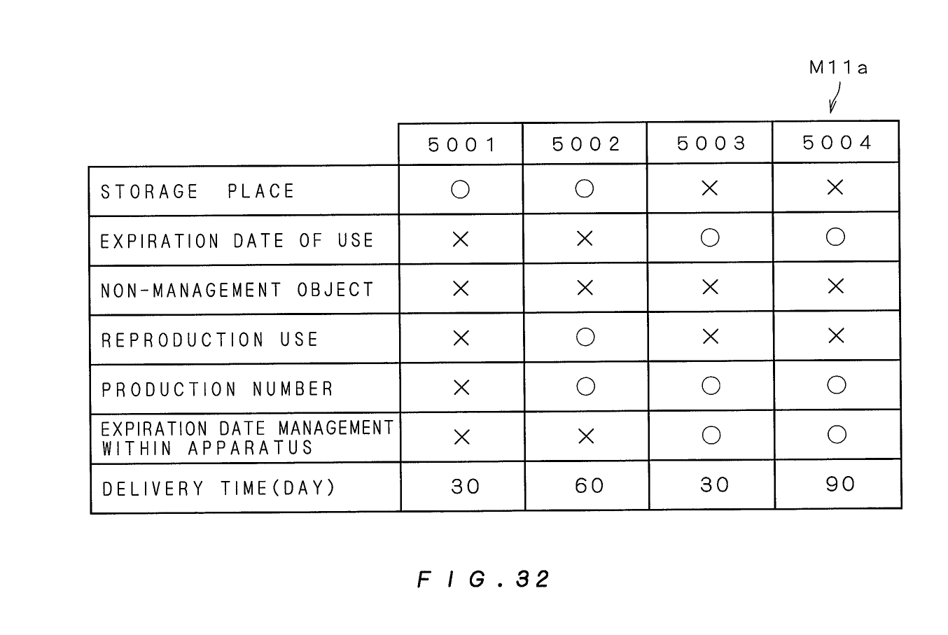

FIG. 30 is a flowchart showing the operations of managing the purchase order or reproduction order of materials in the material management apparatus of the sixth preferred embodiment. Referring to FIG. 30, the data processing part 42 firstly finds the ordering number of material (step SP61). Specifically, referring to FIG. 29, the data processing part 42 receives an estimated number in use of the material in a unit period of time, from an estimated number in use calculating part 2, and receives the current stock number of the material from a stock management part 3. In the case of material requiring no estimation, data of necessary stock number is held. Then, the ordering number of the material is found by performing an operation of reducing the current stock number from the estimated number in use.

Referring to FIG. 30, the data processing part 42 refers to the contents of the material master M11 (step SP62), and judges whether the item “reproduction use” of the material is set to the mark “◯” or not (step SP63). When the result of the step SP63 is “NO”, it goes to step SP64, and only a purchase order of the material is performed. Specifically, referring to FIG. 29, based on the material master M11 and purchase order destination master M17, the data processing part 42 finds the name of the material to be purchased and the name of its manufacturer, and then creates data for purchase order, together with the ordering number. The created data is then inputted to the terminal equipment 6.

As shown in FIG. 30, the terminal equipment 6 displays the data for purchase order on a screen 40 in a display part 7 (step SP65).

On the other hand, when the result of judgement in the step SP63 is “YES”, it goes to step SP66, and the operator determines whether a reproduction order should be performed or not. If the reproduction order is performed (i.e., when the result of the step SP66 is “YES”), it goes to step SP67. As shown in FIG. 29, based on the material master M11 and reproduction order destination master M18, the data processing part 42 finds the name of the material to be reproduced and the name of a manufacturer that reproduces the material, and creates data for reproduction order, together with the number to be reproduced. The created data is then inputted to the terminal equipment 6. At this time, with respect to such a material that has a limited number to be reproduced, the number of times that the material can be subjected to reproduction can be managed by incorporating the production number of the material into the data for reproduction order. Subsequently, as shown in FIG. 30, the terminal equipment 6 displays the data for reproduction order on a screen 41 different from the screen 40 in the display part 7. When the reproduction order is performed, in the stock management part 3, the ordering number for reproduction is subtracted from the current stock number, so that the current stock number is automatically updated.

On the other hand, when the result of the step SP66 is “NO”, it goes to the step SP64 and a purchase order is performed, as in the case that the result of the step SP63 is “NO”. As shown in FIG. 29, based on the material master M11 and the purchase order destination master M17, the data processing part 42 finds the name of the material to be purchased and the name of its manufacturer, and then creates data for purchase order, together with the ordering number. The created data is then inputted to the terminal equipment 6. Then, as shown in FIG. 30, the terminal equipment 6 displays the data for purchase order on the screen 40 in the display part 7 (step SP65).

Thus, with the material management apparatus of the sixth preferred embodiment, the item “reproduction use” is provided to the material master M11, and this item is set to the mark “◯” or “X”. Thereby, it is determined per material as to whether the material is a reproducible material or not. In addition, a reproduction order of material is performed by means of access from the screen 41 different from the screen 40 used in performing a purchase order. Therefore, even if one material has different parameters used in performing each order (e.g., order destinations and unit prices), it is easy and reliable to distinguish a purchase order from a reproduction order of material.

Seventh Preferred Embodiment

The order management part 4 according to the foregoing first to sixth preferred embodiments finds the ordering number of material by performing an operation of subtracting the current stock number from the estimated number in use. It can be considered that the operator who actually performs ordering may increase the ordering number than that found by the order management part 4, with fear of stockout. In this case, if the operator can arbitrarily determine the ordering number, excess order may occur, which can cause stock to be discarded due to the expiration date of use. Accordingly, a seventh preferred embodiment provides a material management apparatus and a material management method which are capable of avoiding excess order by setting the upper limit of the ordering number according to a predetermined rule, while some allowance is made for the ordering number in order to avoid stockout.

FIG. 31 is a block diagram illustrating the constitution of the material management apparatus of the seventh preferred embodiment. An order management part 4 has a comparison part 44 and an operation part 43 connected to the comparison part 44. A minimum master data needed in managing the ordering number for purchase of material having a quality assurance period, that is, only a material master M11a, a purchase order destination master M17 and a quality assurance period master M19, are shown in a storage part 5 in FIG. 31.

FIG. 32 is a diagram illustrating a specific example of the material master M11a in the seventh preferred embodiment. As shown in FIG. 32, the material master M11a is different from the material master M11 shown in FIG. 6, in having the item about delivery times (namely, an estimated period of time from ordering to stockpiling) of various materials.

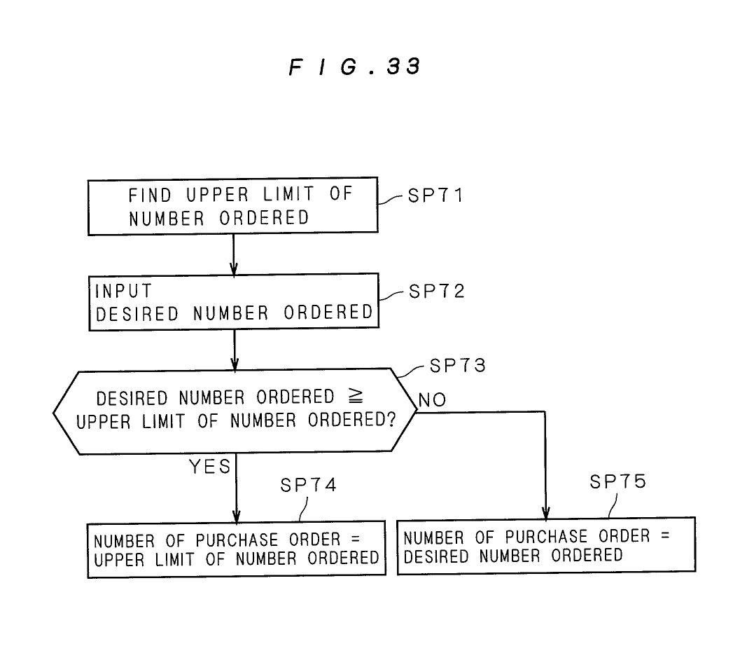

FIG. 33 is a flowchart showing the operations of managing the ordering number for purchase of material in the material management apparatus of the seventh preferred embodiment. Referring to FIG. 33, the order management part 4 firstly finds the upper limit ordering number of material to be purchased (step SP71). Specifically, referring to FIG. 31, the operation part 43 receives an estimated number in use or necessary stock number of the material, from an estimated number in use calculating part 2, and receives the current stock number of the material from a stock management part 3. The operation part 43 also receives data about the material name, delivery time (which is set by month), purchase order destination ID and quality assurance period, from the material master M11a, purchase order destination master M17 and quality assurance period master M19, respectively. The operation part 43 then performs the following operation: Estimated number in use×(Delivery time+Quality assurance period)/Month-Current stock number, thereby to find the upper limit ordering number of the material. The data about the upper limit ordering number thus obtained is then inputted to the comparison part 44. In the case of material having no quality assurance period, the operation part 43 performs the following operation: Estimated number in use X Delivery time/Month-Current stock number, thereby to find the upper limit ordering number of the material.

Referring to FIG. 33, the order management part 4 receives the ordering number that the operator desires (step SP72). Referring to FIG. 31, the desired ordering number is inputted to the comparison part 44.

Referring again to FIG. 33, in the order management part 4, the desired ordering number which is obtained in the step SP72 is compared with the upper limit ordering number which is obtained in the step SP71 (step SP73). This comparison operation is performed in the comparison part 44. As a result, when the desired ordering number exceeds the upper limit ordering number, it goes to step SP74, and the purchase ordering of the material is performed by limiting the ordering number for purchase to the upper limit ordering number. On the other hand, when the desired ordering number is less than the upper limit ordering number, it goes to step SP75, and the purchase order of the material is performed by adopting the desired ordering number as an ordering number for purchase.

Thus, with the material management apparatus of the seventh preferred embodiment, the upper limit ordering number of material is calculated based on a predetermined relational expression, taking the delivery time and the quality assurance period of the material into consideration. Letting the obtained upper limit value be upper limit, the ordering number for purchase of the material is determined, thus avoiding any excess order of the material.

Eighth Preferred Embodiment

When ordering material, it is difficult to know an optimum time to order the material. With respect of a material having a short quality assurance period, if its ordering is too early, the period of time from arrival of the material to its expiration date of use becomes short. With respect of a material having a long delivery time, if its ordering is too late, there occurs the event that the material is not yet stockpiled when necessary. Accordingly, an eighth preferred embodiment provides a material management apparatus and a material management method which are capable of setting the order time of material to an appropriate time.

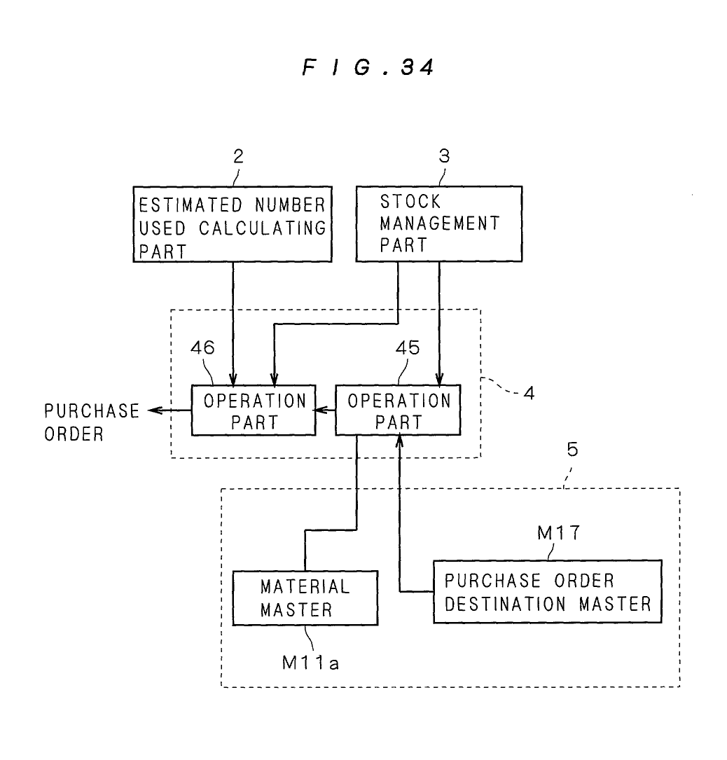

FIG. 34 is a block diagram illustrating the constitution of the material management apparatus of the eighth preferred embodiment. An order management part 4 has an operation part 46 and an operation part 45 connected to the operation part 46. A minimum master data needed in managing the purchase order time of material, that is, only a material master M11a and a purchase order destination master M17, are shown in a storage part 5 in FIG. 34.

FIG. 35 is a flowchart showing the operations of managing the purchase order time of material in the material management apparatus of the eighth preferred embodiment. Referring to FIG. 35, the order management part 4 firstly finds the ordering number for purchase of material (step SP81). Specifically, referring to FIG. 34, the operation part 46 receives every day an estimated number in use or necessary stock number of the material from an estimated number in use calculating part 2, and receives every day the current stock number of the material from a stock management part 3. The operation part 46 then performs an operation of subtracting the current stock number from the estimated number in use, thereby to find the ordering number for purchase of the material.

The order management part 4 then judges whether a predetermined condition to allow for purchase order is satisfied or not (step SP82). Specifically, referring to FIG. 34, the operation part 45 receives every day data about the actual number used of the material in a unit period of time, and data about the current stock number of the material, from the stock management part 3. The operation part 45 also receives the material name, delivery time, and the purchase order destination ID, from the material master M11a and the purchase order destination master M17, respectively. In the case of material, only one piece of which is needed in a half-year, the actual number used of such material per unit period of time, is indicated by figures expressed in decimal.

The operation part 45 performs every day the following operation: Actual number used of material per unit period of time×Delivery time/Month-(Current stock number+1). When the result is zero or positive, it is judged that the condition to allow for purchase order is satisfied. When the result is negative, it is judged that this condition is not satisfied. The reason whey “1” is added to the current stock number in the second term of the above expression is that an allowance for the stock number of the material enables to avoid such an event that the stock is exhausted if the necessary amount of the material is temporarily increased due to trouble etc.

Referring to FIG. 35, when the result of judgement in the step SP82 is “YES”, it goes to step SP83, and a purchase order of the material is performed. When the result is “NO”, it goes to step SP84, and no purchase order of the material is performed on that day (i.e., on standby). The foregoing process is performed again on the following day.

Thus, with the material management apparatus of the eighth preferred embodiment, the order time of material is determined by taking into consideration the actual number used of the material per unit period of time (which is counted by month in this embodiment), the delivery time and current stock number of the material. Therefore, the order time of the material can be set to an appropriate time.

Ninth Preferred Embodiment

In the interior of the material management apparatuses according the foregoing first to eighth preferred embodiments, whether the material is a chemical or apparatus part, every material is managed in the unit of “piece”, which makes it easy to handle daily input of arrival and delivery of materials. Meanwhile, those who manufacture or reproduce materials usually adopt, as the unit of material, the units other than “piece” (e.g., set and capacity), because of the circumstances in manufacturing lines. Hence, if a material is ordered through the order management part 4 by using the unit of piece, there occurs mismatch with the unit adopted in the manufacturer receiving the order. Accordingly, a ninth preferred embodiments provides a material management apparatus and a material management method which are capable of performing ordering of material by employing the unit of the material matched with the unit adopted by its manufacturer, in the order management and stock management of the material.

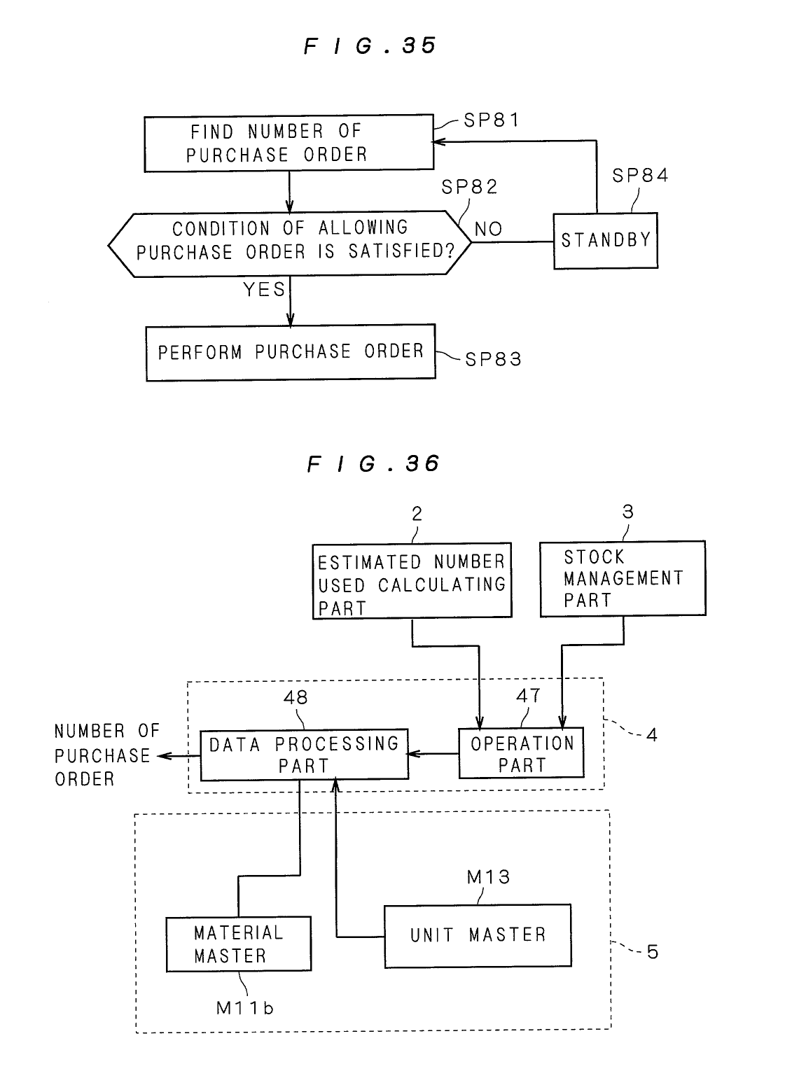

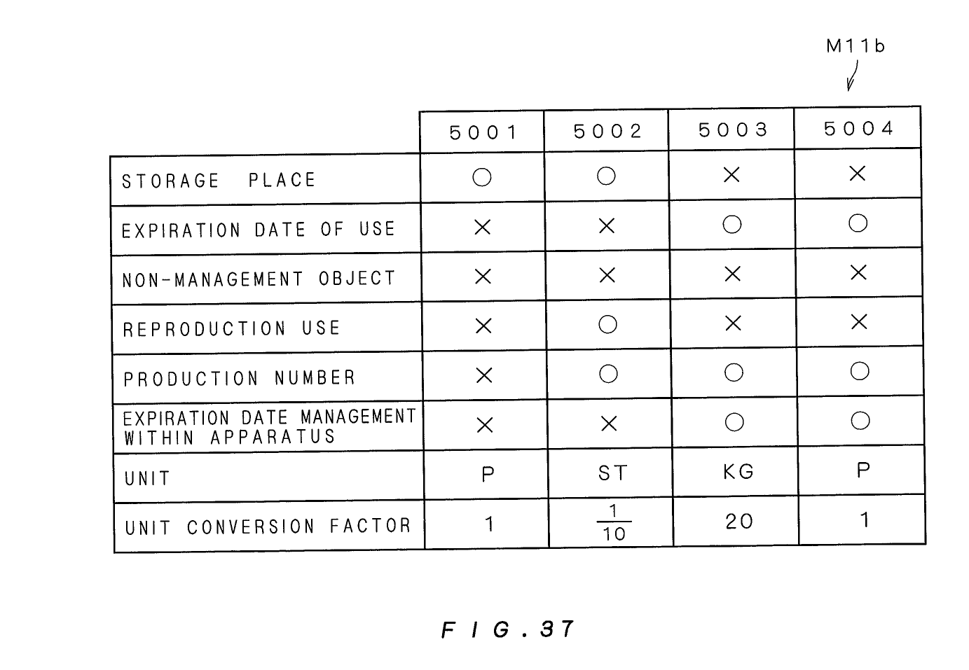

FIG. 36 is a block diagram illustrating the constitution of the material management apparatus of the ninth preferred embodiment. An order management part 4 has a data processing part 48 and an operation part 47 connected to the data processing part 48. A minimum master data needed in managing conversion of the unit of material, that is, only a material master M11b and a unit master M13, are shown in a storage part 5 in FIG. 36.

FIG. 37 is a diagram illustrating a specific example of the material master M11b in the ninth preferred embodiment. As shown in FIG. 37, the material master M11b is different from the material master M11 shown in FIG. 6, in having the item about the unit ID of materials and the item about the unit conversion factors. If the unit used in the interior of this material management apparatus is the same as the unit adopted by those who manufacture or reproduce the material, the unit conversion factor is “1”.

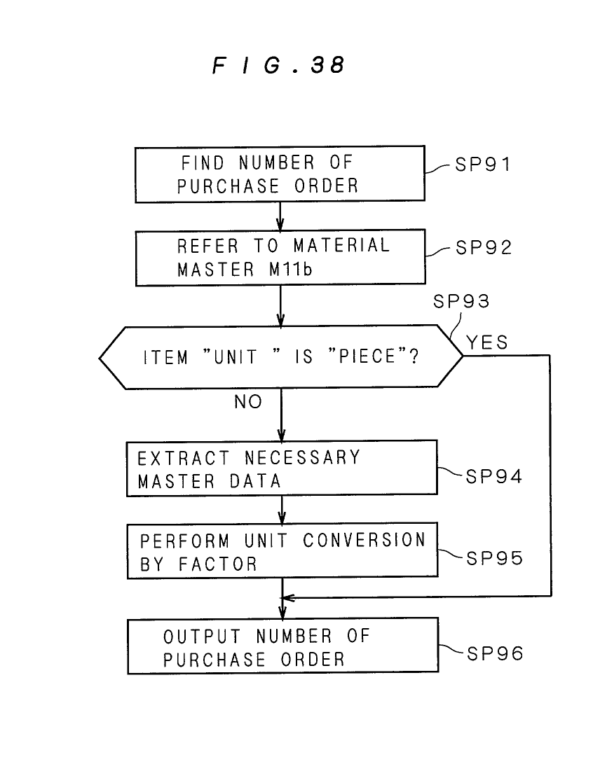

FIG. 38 is a flowchart showing the operations of managing the unit conversion of material in the material management apparatus of the ninth preferred embodiment. Referring to FIG. 38, the order management part 4 firstly finds the ordering number for purchase of material (step SP91). Specifically, referring to FIG. 36, the operation part 47 receives an estimated number in use or necessary stock number of the material from an estimated number in use calculating part 2, and receives the current stock number of the material from a stock management part 3. The operation part 47 then performs an operation of subtracting the current stock number from the estimated number in use, thereby to find the ordering number for purchase of the material.

The data processing part 48 then refers to the contents of the material master M11b to judge whether the item “unit” of the material is set to “piece” or not (step SP93). When the result of judgement in the step SP93 is “YES”, it goes to step SP96, and the data processing part 48 performs a purchase order of the material in the unit “piece” that is common to the interior of this material management apparatus.

When the result of the step SP93 is “NO”, it goes to step SP94, and the data processing part 48 extracts a master data needed in managing the unit conversion of the material, from a plurality of master data stored in the storage part 5 (step SP94). Specifically, referring to FIG. 36, the data processing part 48 extracts the material ID, material name, the unit, unit ID and unit conversion factor from the material master M11b and unit master M13, respectively, in order to receive these data.

Referring to FIG. 38, the data processing part 48 performs the unit conversion of material (step SP95). Specifically, referring to FIG. 36, the data processing part 48 performs such an operation of multiplying the ordering number for purchase in the unit of piece (which is received from the operation part 47) by the unit conversion factor, thereby converting the unit of the material. Referring to FIG. 38, it goes to step SP96, and a purchase order of the material in the unit after unit conversion is performed by the data processing part 48.

Thus, with the material management apparatus of the ninth preferred embodiment, in the order management part 4, the unit of material used in the interior of the material management apparatus is automatically converted into the unit of the material adopted by those who manufacture or reproduce the material, so that the material is ordered in the unit after unit conversion. Therefore, those who manufacture or reproduce the material can receive ordering in the unit that they adopt.

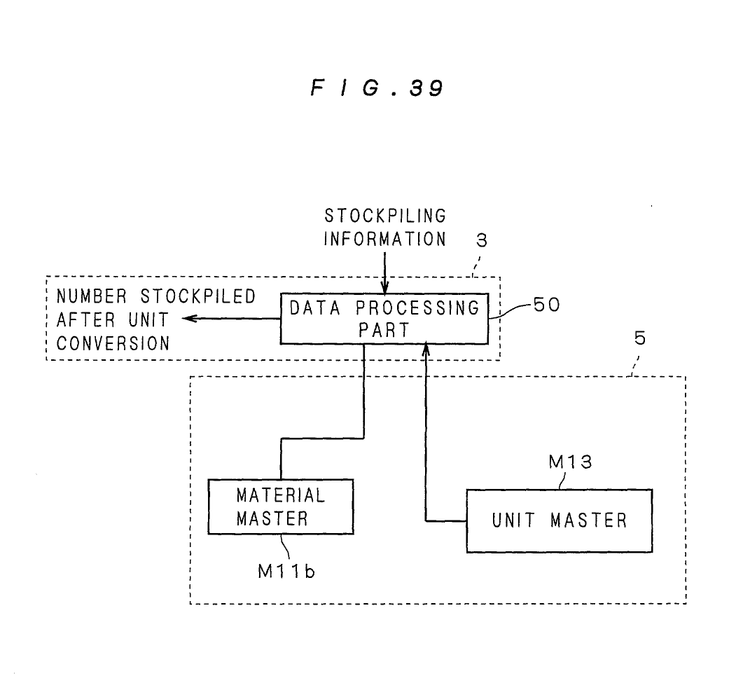

Although in the foregoing description, the unit conversion is performed in the order management part 4, the reverse unit conversion can be performed in the stock management part 3. Specifically, referring to FIG. 39, when receiving a material from a manufacturer in the unit of set, for example, in a data processing part 50, the number of sets received (which is contained in the stock information) is multiplied by the factor expressed in the inverse number of the unit conversion factor as described, thereby converting the unit of set into the unit of piece. The same is true for the case that the unit conversion factor is an integer.

Although the foregoing description has been made of the case of performing a purchase order of material, the same is true for the case of performing a reproduction order.

While the invention has been shown and described in detail, the foregoing description is in all aspects illustrative and not restrictive. It is therefore understood that numerous modifications and variations can be devised without departing from the scope of the invention.

What is claimed is:

1. A material management apparatus comprising:
an estimated number in use calculating part to calculate, based on data of an operating manufacturing line, an estimated number in use of material including apparatus parts in a unit period of time;
a stock management part to manage stock of said material on data; and
an order management part to output data on an ordering number of said material based on data of said estimated number in use from said estimated number in use calculating part and data of a current stock number of said material from said stock management part.

2. The material management apparatus according to claim 1 wherein
said estimated number in use calculating part has:
a first operation part to calculate an endurance limit of said material based on data of the number of wafers processed in a unit period of time and data of the number of said material used in said unit period of time; and
a second operation part to calculate said estimated number in use based on data of the number of wafers to be processed and data of said endurance limit from said first operation part.

3. The material management apparatus according to claim 1 further comprising:
a storage part to store data of plural predetermined items about said material,
wherein said stock management part performs stock management of said material by referring to said data stored in said storage part, and
said order management part performs order management of said material by referring to said data stored in said storage part.

4. The material management apparatus according to claim 1 further comprising:
a storage part to store data of plural predetermined items about said material,
wherein said material includes chemicals,
said storage part further stores masters having plural management items including items needed in managing said apparatus parts and items needed in managing said chemicals, and
said stock management part manages, per said material as a management object, by selecting a specific item from said plural management items.

5. The material management apparatus according to claim 3 wherein said plural predetermined items include an item about storage place of said material.

6. The material management apparatus according to claim 3 wherein
said plural predetermined items include an item about expiration date of use of said material.

7. The material management apparatus according to claim 3 wherein
said plural predetermined items include an item about expiration date of use of said material currently used within a processing apparatus.

8. The material management apparatus according to claim 3 wherein
said plural predetermined items include an item indicating whether said material is currently a management object or not.

9. The material management apparatus according to claim 8 further comprising:
a display part to separately display, on different screens, a stock management data of said material that is currently a management object and a stock management data of said material that is currently not a management object.

10. The material management apparatus according to claim 3 wherein
said plural predetermined items include an item indicating whether or not said material is a material usable by repetitive reproduction.

11. The material management apparatus according to claim 10 further comprising:
a display part to separately display, on different screens, an order data of said material to be purchased and an order data of said material to be reproduced.

12. The material management apparatus according to claim 1 wherein
said order management part outputs data of said ordering number of said material based on data of said estimated number in use, data of said current stock number, and an upper limit value of an ordering number that is defined by a predetermined expression.

13. The material management apparatus according to claim 12 wherein
said upper limit value of said ordering number is defined by said predetermined expression using a delivery time of said material as a parameter.

14. The material management apparatus according to claim 12 wherein
when said material is a material having a quality assurance period, said upper limit value of said ordering number is defined by said predetermined expression using, as a parameter, a delivery time and said quality assurance period of said material.

15. The material management apparatus according to claim 1 wherein
said order management part determines an order time of said material based on a predetermined expression using, as a parameter, an actual number used of said material in a unit period of time, a delivery time of said material, and said current stock number of said material.

16. The material management apparatus according to claim 1 wherein
said order management part outputs data of an ordering number of said material by converting the unit of said material adopted within said material management apparatus, into the unit of said material adopted by a manufacturer to which said material is ordered.

17. A material management method comprising the steps of:
(a) calculating an estimated number in use of material including apparatus parts in a unit period of time, based on data of an operating manufacturing line;
(b) finding a current stock number of said material; and
(c) determining an ordering number of said material based on data of said estimated number in use and data of said current stock number.

18. The material management method according to claim 17 wherein said step (a) has the steps of:
(a-1) calculating an endurance limit of said material based on data of the number of wafers processed in a unit period of time and data of the number of said material used in said unit period of time; and
(a-2) calculating said estimated number in use, based on data of a number of wafers to be processed and data of said endurance limit.
